(19) United States
(12) Patent Application Publication
(10) Pub. No.: US 2025/0256945 A1
(43) Pub. Date: Aug. 14, 2025

(54) ACCESSIBLE DRUM-REEL FRAME FOR PIPE INSPECTION CAMERA SYSTEM

(71) Applicant: SeeScan, Inc., San Diego, CA (US)

(72) Inventors: Andrew P. Corvin, San Diego, CA (US); Michael J. Martin, San Diego, CA (US); Mark S. Olsson, La Jolla, CA (US); Alexander L. Warren, Escondido, CA (US); David C. Parsons, San Marcos, CA (US)

(21) Appl. No.: 19/018,842

(22) Filed: Jan. 13, 2025

Related U.S. Application Data
(60) Provisional application No. 63/625,259, filed on Jan. 25, 2024.
(60) Provisional application No. 63/552,522, filed on Feb. 12, 2024.

(51) Int. Cl. B66D 1/28; F16L 55/30; F16L 101/30

(52) U.S. Cl. CPC B66D 1/28; F16L 55/30; F16L 2101/30

(57) ABSTRACT

A pipe inspection system includes a cable storage drum and a housing configured to removably receive and rotatably support the cable storage drum. A push-cable with multiple conductors is stored in the drum. An inspection camera may be attached to a distal end of the push-cable. The housing includes an accessible frame outer shell which can be opened to allow access to, and/or replacement of the cable storage drum. The frame has a hinged or otherwise transformably coupled portion that can be opened and closed. At least one latching/locking mechanism is provided to allow the frame to be opened, or closed and latched/locked. The frame accepts different size drum-reels. The frame may be configured to accept a removable bearing ring which mates with the cable storage drum. The frame may include a handle, as well as one or more wheels to allow the cable storage drum to be relocated.

### CROSS-REFERENCE TO RELATED APPLICATIONS

This application claims priority under 35 U.S.C. § 119(e) to U.S. Provisional Patent Application Ser. No. 63/625,259, entitled ACCESSIBLE DRUM-REEL FRAME FOR PIPE INSPECTION CAMERA SYSTEM, filed Jan. 25, 2024, and Ser. No. 62/552,522,entitled ACCESSIBLE DRUM-REEL FRAME FOR PIPE INSPECTION CAMERA SYSTEM, filed Feb. 12, 2024, the content of which is incorporated by reference herein in its entirety for all purposes.

### FIELD

This disclosure relates generally to pipe inspection systems employing a camera head connected to the end of a push-cable payed out from a rotatable cable drum. More specifically, but not exclusively, this disclosure relates to a cable storage drum with a removable module for housing electronics and other components, including a battery module interface. The cable storage drum does not require any slip-rings to maintain connectivity between the battery module interface and the electronics. Additionally, an accessible drum-reel frame is provided which allows the cable drum to be easily removed for maintenance, and/or replacement. The drum-reel frame may be configured to accept cable drums of various sizes and shapes.

### BACKGROUND

FIG. 1 illustrates a pipe inspection system including a cable storage drum and a housing configured to removably receive and rotatably support the cable storage drum, as known in the prior art. The cable storage drum typically includes an outer drum-reel for deploying or retracting a push-cable or hose into, or out of, a pipe or conduit to be inspected. A camera head or other inspection equipment may be operatively connected to a distal end of the push-cable.

The drum-reel is typically free to rotate bidirectionally around an inner hub which is stationary. The hub may be secured to a frame. The hub may be configured to house a power source such as a battery module, and other components, either electrical or mechanical. Electrical connectivity between the cable and the hub components is accomplished via one or more slip-rings which allow connectivity to be maintained even while the cable drum is rotating. Slip-rings do not always provide perfect electrical connectivity, require maintenance, and may be subject to failure.

Cable storage drums typically have a cable-reel (also known as a drum-reel) and are positioned partially or completely within a protective enclosure or housing. The housing is supported by a frame. The drum-reel is free to spin bidirectionally around a hub which is secured to the frame. Current frame designs do not allow fast and easy access to the cable storage drum, nor are they configured to allow the use of a large range of different cable-drum sizes and shapes.

Accordingly, the present invention is directed towards addressing the above-described problems and other problems associated with quickly and accurately obtaining and processing accurate utility location data.

### SUMMARY

This disclosure relates generally to pipe inspection systems employing a camera head connected to the end of a push-cable payed out from a rotatable cable drum. More specifically, but not exclusively, this disclosure relates to a cable storage drum with a removable module for housing electronics and other components, including a battery module interface. The cable storage drum does not require any slip-rings to maintain connectivity between the battery module interface and the electronics.

In one aspect, the present disclosure relates to a modular drum assembly with an inner core module which mates with a substantially hollow core outer cone removably attachable to a cable storage drum. The inner core module provides a housing for various component interfaces. With multiple component interfaces it provides the ability to quickly swap out batteries, add or remove different electrical and mechanical components, e.g. wireless and satellite positioning components, cable reel counters, sensor components, etc., greatly reduces inspection downtime, and improves the type and quality of captured inspection images and other data.

In another aspect, a modular drum assembly includes an inner core module which is removably attachable to an outer cone. The inner core module and the outer cone which are shaped to mate and lock together. The outer cone is removably attachable to a cable storage drum. Once attached, the modular drum assembly and the cable storage drum remain stationary relative to each other, thereby allowing both the modular drum assembly and the cable storage drum to rotate bidirectionally around a common hub. Since the cable storage drum and the modular drum assembly move in unison, the electrical and mechanical components inside the inner hub also move at the same time. Since connectivity to any inner hub components is constant, and independent from any rotation of the cable storage drum, the need for any slip-rings to maintain connectivity between components that do not move together is eliminated. This provides more reliable communication of captured images and data, and therefore, a more robust and reliable utility pipe or conduit inspection system. The outer cone may include an aperture for providing front-side access to the inner core module.

In another aspect, the hollow inner core is configured as a cartridge that can be plugged into the outer cone. When connected together, the inner core mates (makes contact) with a contact plate that is sealed inside the outside cone. The cartridge is hollow with multiple interfaces for connecting to various electrical and mechanical components, including one or both of wireless or satellite positioning modules or components (e.g. WiFi, GPS, GNSS, antennas, receivers, transmitter, transceivers, reel counters, sensors, battery modules and components, etc.).

On the opposite side of the inner core, the contact plate can be attached to a push-cable. The push-cable includes electrical contacts which may be attached to a camera at the distal end of the push-cable. The camera may be a digital self-leveling camera. Examples of a push-cable and video push cable system configurations are described in the following incorporated United States Patents and Patent applications which may be used in conjunction with the disclosure herein in various embodiments.

Details of example methods and devices that may be used in or combined with the devices and methods described herein, are disclosed in co-assigned patents and patent applications including: U.S. Pat. No. 5,939,679, issued Aug. 17, 1999, entitled VIDEO PUSH CABLE; U.S. Pat. No. 6,545,704, issued Apr. 8, 1999, entitled VIDEO PIPE INSPECTION DISTANCE MEASURING SYSTEM; U.S. Pat. No. 6,831,679, issued Dec. 14, 2004, entitled VIDEO CAMERA HEAD WITH THERMAL FEEDBACK LIGHTING CONTROL; U.S. Pat. No. 6,862,945, issued Mar. 8, 2005, entitled CAMERA GUIDE FOR VIDEO PIPE INSPECTION SYSTEM; U.S. Pat. No. 6,958,767, issued Oct. 25, 2005, entitled VIDEO PIPE INSPECTION SYSTEM EMPLOYING NON-ROTATING CABLE STORAGE DRUM; U.S. patent application Ser. No. 12/704,808, filed Feb. 13, 2009, entitled PIPE INSPECTION SYSTEM WITH REPLACEABLE CABLE STORAGE DRUM; U.S. patent application Ser. No. 13/647,310, filed Feb. 13, 2009, entitled PIPE INSPECTION SYSTEM APPARATUS AND METHOD; U.S. patent application Ser. No. 13/346,668, filed Jan. 9, 2012, entitled PORTABLE CAMERA CONTROLLER PLATFORM FOR USE WITH PIPE INSPECTION SYSTEM; U.S. patent application Ser. No. 14/749,545, filed Jan. 30, 2012, entitled ADJUSTABLE VARIABLE RESOLUTION

INSPECTION SYSTEMS AND METHODS; U.S. Pat. No. 8,289,385, issued Oct. 16, 2012, entitled PUSH-CABLE FOR PIPE INSPECTION SYSTEM; U.S. Pat. No. 8,395,661, issued Mar. 12, 2013, entitled PIPE INSPECTION SYSTEM WITH SELECTIVE IMAGE CAPTURE; U.S. patent application Ser. No. 13/826,112, filed March 14 2013, entitled SYSTEMS AND METHODS INVOLVING A SMART CABLE STORAGE DRUM AND NETWORK NODE FOR TRANSMISSION OF DATA; U.S. patent application Ser. No. 14/033,349, filed Sep. 20, 2013, entitled PIPE INSPECTION SYSTEM WITH SNAP-ON PIPE GUIDES; U.S. Pat. No. 8,540,429, issued Sep. 24, 2013, entitled SNAP ON PIPE GUIDE; U.S. Pat. No. 8,587,648, issued Nov. 19, 2013, entitled SELF-LEVELING CAMERA HEAD; U.S. patent application Ser. No. 14/136,104, filed Dec. 20, 2013, entitled ROTATING CONTACT ASSEMBLIES FOR SELF-LEVELING CAMERA HEADS; U.S. patent application Ser. No. 14/203,485, filed Mar. 10, 2014, entitled PIPE INSPECTION CABLE COUNTER AND OVERLAY MANAGEMENT SYSTEM; U.S. patent application Ser. No. 14/207,527, filed Mar. 12, 2014, entitled ROTATING CONTACT ASSEMBLIES FOR SELF-LEVELING CAMERA HEADS; U.S. patent application Ser. No. 14/216,358, filed Mar. 17, 2014, entitled SMART CABLE STORAGE DRUM AND NETWORK NODE SYSTEM AND METHODS; U.S. patent application Ser. No. 14/557,163, filed Dec. 1, 2014, entitled ASYMMETRIC DRAG FORCE BEARINGS; U.S. Pat. No. 8,908,027, issued Dec. 9, 2014, entitled ASYMMETRIC DRAG FORCE BEARING FOR USE WITH PUSH-CABLE STORAGE DRUM; U.S. Pat. No. 8,970,211, issued Mar. 3, 2015, entitled PIPE INSPECTION CABLE COUNTER AND OVERLAY MANAGEMENT SYSTEM; U.S. patent application Ser. No. 14/642,596, filed Mar. 9, 2015, entitled PIPE CLEARING CABLES AND APPARATUS; U.S. Pat. No. 8,984,698, issued Mar. 24, 2015, entitled LIGHT WEIGHT SEWER CABLE; U.S. patent application Ser. No. 14/746,590, filed Jun. 22, 2015, entitled THERMAL EXTRACTION ARCHITECTURES FOR CAMERA AND LIGHTING DEVICES; U.S. Pat. No. 9,066,446, issued Jun. 23, 2015, entitled THERMAL EXTRACTION ARCHITECTURE FOR CAMERA HEADS, INSPECTION SYSTEMS, AND OTHER DEVICES AND SYSTEMS; U.S. Pat. No. 9,080,992, issued Jul. 14, 2015, entitled ADJUSTABLE VARIABLE RESOLUTION INSPECTION SYSTEMS AND METHODS; U.S. Pat. No. 9,134,255, issued Sep. 15, 2015, entitled PIPE INSPECTION SYSTEM WITH SELECTIVE CAPTURE; U.S. patent application Ser. No. 14/935,878, filed Nov. 9, 2015, entitled INSPECTION CAMERA DEVICES AND METHODS WITH SELECTIVELY ILLUMINATED MULTISENSOR IMAGING; U.S. patent application Ser. No. 14/970,362, filed Dec. 15, 2014, entitled COAXIAL VIDEO PUSH-CABLES FOR USE IN INSPECTION SYSTEMS; U.S. Pat. No. 9,222,809, issued Dec. 29, 2015, entitled PORTABLE PIPE INSPECTION SYSTEMS AND APPARATUS; U.S. patent application Ser. No. 15/050,267, filed Feb. 22, 2016, entitled SELF-LEVELING CAMERA HEADS; U.S. Pat. No. 9,277,105, issued Mar. 1, 2016, entitled SELF-LEVELING CAMERA HEADS; U.S. patent application Ser. No. 15/264,355, filed Sep. 13, 2016, entitled HIGH BANDWIDTH VIDEO PUSH-CABLES FOR PIPE INSPECTION SYSTEMS; U.S. Pat. No. 9,448,376, issued Sep. 20, 2016, entitled HIGH BANDWIDTH PUSH-CABLES FOR VIDEO PIPE INSPECTION SYSTEMS; U.S. Pat. No. 9,468,954, issued Oct. 18, 2016, entitled PIPE INSPECTION SYSTEM WITH JETTER PUSH-CABLE; U.S. Pat. No. 9,477,147, issued Oct. 25, 2016, entitled SPRING ASSEMBLIES WITH VARIABLE FLEXIBILITY FOR USE WITH PUSH-CABLES AND PIPE INSPECTION SYSTEMS; U.S. patent application Ser. No. 15/369,693, filed Dec. 5, 2016, entitled CABLE STORAGE DRUM WITH MOVEABLE CCU DOCKING APPARATUS; U.S. Pat. No. 9,521,303, issued Dec. 13, 2016, entitled CABLE STORAGE DRUM MOVABLE CCU DOCKING APPARATUS; U.S. patent application Ser. No. 15/425,785, filed Feb. 6, 2017, entitled METHOD AND APPARATUS FOR HIGH-SPEED DATA TRANSFER EMPLOYING SELF-SYNCHRONIZING QUADRATURE AMPLITUDE MODULATION; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION; U.S. patent application Ser. No. 15/483,924, filed Apr. 10, 2017, entitled SYSTEMS AND METHODS FOR DATA TRANSFER USING SELF-SYNCHRONIZING QUADRATURE AMPLITUDE MODULATION; U.S. Pat. No. 9,625,602, issued Apr. 18, 2017, entitled SMART PERSONAL COMMUNICATION DEVICES AS USER INTERFACES; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION; U.S. patent application Ser. No. 15/590,964, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; U.S. patent application Ser. No. 15/670,845, filed Aug. 7, 2017, entitled HIGH FREQUENCY AC-POWERED DRAIN CLEANING AND INSPECTION APPARATUS AND METHODS; U.S. patent application Ser. No. 15/701,247, filed Sep. 11, 2017, entitled PIPE INSPECTION SYSTEMS WITH SELF-GROUNDING PORTABLE CAMERA CONTROLLERS; U.S. Pat. No. 9,769,366, issued Sep. 19, 2017, entitled ELF-GROUNDING TRANSMITTING PORTABLE CAMERA CONTROLLER FOR USE WITH PIPE INSPECTION SYSTEMS; U.S. Pat. No. 9,791,382, issued Oct. 17, 2017, entitled PIPE INSPECTION SYSTEM WITH JETTER PUSH-CABLE; U.S. patent application Ser. No. 15/728,410, filed Oct. 9, 2017, entitled PIPE INSPECTION SYSTEM WITH JETTER PUSH-CABLE; U.S. patent application Ser. No. 15/805,007, filed Nov. 6, 2017, entitled PIPE INSPECTION SYSTEM CAMERA HEADS; U.S. patent application Ser. No. 15/806,219, filed Nov. 7, 2017, entitled MULTI-CAMERA PIPE INSPECTION APPARATUS, SYSTEMS AND METHODS; U.S. patent application Ser. No. 15/811,264, filed Nov. 13, 2017, entitled SPRING ASSEMBLIES WITH VARIABLE FLEXIBILITY FOR USE WITH PUSH-CABLES AND PIPE INSPECTION SYSTEMS; U.S. Pat. No. 9,824,433, issued Nov. 21, 2017, entitled PIPE INSPECTION SYSTEM CAMERA HEADS; U.S. Pat. No. 9,829,783, issued Nov. 28, 2017, entitled SPRING ASSEMBLIES WITH VARIABLE FLEXIBILITY FOR USE WITH PUSH-CABLES AND PIPE INSPECTION SYSTEMS; U.S. Pat. No. 9,835,564, issued Dec. 5, 2017, entitled MULTI-CAMERA PIPE INSPECTION APPARATUS, SYSTEMS, AND METHODS; U.S. patent application Ser. No. 15/919,077, filed Mar. 27, 2018, entitled PORTABLE PIPE INSPECTION SYSTEMS AND METHODS; U.S. Pat. No. 9,914,157, issued Mar. 13, 2018, entitled METHODS AND APPARATUS FOR CLEARING OBSTRUCTIONS WITH A JETTER PUSH-CABLE APPARATUS; U.S. patent application Ser. No. 15/922,703, filed Mar. 15, 2018, entitled SELF-LEVELING INSPECTION SYSTEMS AND METHODS; U.S. Pat. No. 9,924,139, issued Mar. 20, 2018, entitled PORTABLE PIPE INSPECTION SYSTEMS AND APPARATUS; U.S. Pat. No. 9,927,368, issued Mar. 27, 2018, entitled SELF-LEVELING INSPECTION SYSTEMS AND METHODS; U.S. Provisional Patent Application 62/686,589, filed Jun. 18, 2018, entitled MULTI-DIELECTRIC COAXIAL PUSH-CABLES; U.S. Provisional Patent Application 62/726,500, filed Sep. 4, 2018, entitled VIDEO PIPE INSPECTION SYSTEMS, DEVICES, AND METHODS INTEGRATED WITH NON-VIDEO DATA RECORDING AND COMMUNICATION FUNCTIONALITY; U.S. Provisional Patent Application 62/756,538, filed Nov. 6, 2018, entitled ROBUST AND LOW COST IMPEDANCE CONTROLLED SLIP RINGS; U.S. Provisional Patent Application 62/768,760, filed Nov. 16, 2018, entitled PIPE INSPECTION AND/OR MAPPING CAMERA HEADS, SYSTEMS, AND METHODS; U.S. Provisional Patent Application 62/794,863, filed Jan. 21, 2019, entitled HEAT EXTRACTION ARCHITECTURE FOR COMPACT VIDEO HEADS; U.S. patent application Ser. No. 16/443,789, filed Jun. 17, 2019, entitled MULTI-DIELECTRIC COAXIAL PUSH-CABLES AND ASSOCIATED APPARATUS; U.S. Pat. No. 10,356,360, issued Jul. 16, 2019, entitled HIGH BANDWIDTH VIDEO PUSH-CABLE FOR PIPE INSPECTION SYSTEMS; U.S. Pat. No. 10,359,368, issued Jul. 23, 2019, entitled PIPE INSPECTION SYSTEM WITH JETTER PUSH-CABLE; U.S. Pat. No. 10,379,436, issued Aug. 13, 2019, entitled SPRING ASSEMBLIES WITH VARIABLE FLEXIBILIY FOR USE WITH PUSH-CABLES AND PIPE INSPECTION SYSTEMS; U.S. Pat. No. 10,440,332, issued Oct. 8, 2019, entitled INSPECTION CAMERA DEVICES AND METHODS WITH SELECTIVELY ILLUMINATED MULTISENSOR IMAGINING; U.S. Pat. No. 10,527,402, issued Jan. 7, 2020, entitled PIPE INSPECTION SYSTEM CABLE COUNTER AND OVERLAY MANAGEMENT SYSTEM; U.S. Pat. No. 10,585,012, issued Mar. 10, 2020, entitled PORTABLE CAMERA CONTROLLER FOR USE WITH PIPE INSPECTION SYSTEMS; U.S. Pat. No. 10,613,034, issued Apr. 7, 2020, entitled SELF-LEVELING INSPECTION SYSTEMS AND METHODS; U.S. Pat. No. 10,715,703, issued Jul. 14, 2020, entitled SELF-LEVELING CAMERA HEADS; U.S. Pat. No. 10,761,233, issued Sep. 1, 2020, entitled SONDES AND METHODS FOR USE WITH BURIED LINE LOCATOR SYSTEMS; U.S. Pat. No. 10,764,541, issued Sep. 1, 2020, entitled COAXIAL VIDEO PUSH-CABLES FOR USE IN INSPECTION SYSTEMS; U.S. patent application Ser. No. 17/087,554, filed Nov. 2, 2020, entitled PORTABLE PIPE INSPECTION SYSTEMS AND METHODS; U.S. Pat. No. 10,834,364, issued Nov. 10, 2020, entitled PORTABLE PIPE INSPECTION SYSTEMS AND METHODS; U.S. Pat. No. 10,841,144, issued Nov. 17, 2020, entitled SYSTEM AND METHODS FOR DATA TRANSFER USING SELF-SYNCHRONIZING QUADRATURE AMPLITUFE MODULATION (QAM); U.S. Pat. No. 10,855,950, issued Dec. 1, 2020, entitled HIGH BANDWIDTH VIDEO PUSH-CABLES FOR PIPE INSPECTION SYSTEMS; U.S. Pat. No. 10,863,064, issued Dec. 8, 2020, entitled CABLE STORAGE DRUM WITH MOVEABLE CCU DOCKING APPARATUS; U.S. Pat. No. 10,907,690, issued Feb. 2, 2021, entitled PIPE INSPECTION SYSTEMS WITH ASSYMETRIC DRAG FORCE BEARINGS; U.S. Pat. No. 10,921,263, issued Feb. 16, 2021, entitled PIPE INSPECTION SYSTEM WITH JETTER PUSH-CABLE; U.S. patent application Ser. No. 17/182,113, filed Feb. 22, 2021, entitled VIDEO PIPE INSPECTION SYSTEMS; U.S. patent application Ser. No. 17/202,128, filed Mar. 15, 2021, entitled BORING INSPECTION SYSTEMS AND METHODS; U.S. Pat. No. 10,955,583, issued Mar. 23, 2021, entitled BORING INSPECTION SYSTEMS AND METHODS; U.S. Pat. No. 10,976,462, issued Apr. 13, 2021, entitled VIDEO INSPECTION SYSTEMS WITH PERSONAL COMMUNICATION DEVICE USER INTERFACES; U.S. Pat. No. 10,992,849, issued Apr. 27, 2021, entitled PIPE INSPECTION SYSTEMS WITH SELF-GROUNDING PORTABLE CAMERA CONTROLLERS; U.S. Pat. No. 11,016,381, issued May 25, 2021, entitled SPRING ASSEMBLIES WITH VARIABLE FLEXIBLE FOR USE WITH PUSH-CABLES AND PIPE INSPECTION SYSTEMS; U.S. patent application Ser. No. 17/397,940, filed Aug. 9, 2021, entitled INSPECTION SYSTEM PUSH-CABLE GUIDE APPARATUS; U.S. Pat. No. 11,088,890, issued Aug. 10, 2021, entitled VIDEO INSPECTION SYSTEMS AND METHODS USING SELF-SYNCHRONIZING QAM; U.S. Pat. No. 11,132,781, issued Sep. 28, 2021, entitled PIPE INSPECTION SYSTEM CAMERA HEADS; U.S. patent application Ser. No. 17/528,155, filed Nov. 16, 2021, entitled PORTABLE CAMERA CONTROLLER PLATFORM FPR USE WITH PIPE INSPECTION SYSTEMS; U.S. Pat. No. 11,178,317, issued Nov. 16, 2021, entitled HEAT EXTRACTION APPARATUS; U.S. patent application Ser. No. 17/528,956, filed Nov. 17, 2021, entitled VIDEO INSPECTION SYSTEM APPARATUS AND METHODS WITH RELAY MODULES AND CONNECTION PORTS; U.S. patent application Ser. No. 17/531,533, filed Nov. 19, 2021, entitled INPUT MULTIPLEXED SIGNAL PROCESSING APPARATUS AND METHODS; U.S. patent application Ser. No. 17/532,938, filed Nov. 22, 2021, entitled PIPE INSPECTION AND/OR MAPPING CAMERA HEADS, SYSTEMS, AND METHODS; U.S. Pat. No. 11,187,822, issued Nov. 30, 2021, entitled SONDE DEVICES INCLUDING SECTIONAL FERRITE CORE STRUCTURE; U.S. Pat. No. 11,187,971, issued Nov. 30, 2021, entitled ROTATING CONTACT ASSEMBLIES FOR SELF-LEVELING CAMERA HEADS; U.S. Pat. No. 11,199,510, issued Dec. 14, 2021, entitled PIPE INSPECTION AND CLEANING APPARATUS AND SYSTEMS; U.S. Pat. No. 11,209,115, issued Dec. 28, 2021, entitled PIPE INSPECTION AND/OR MAPPING CAMERA HEADS, SYSTEMS, AND METHODS; U.S. Pat. No. 11,209,334, issued Dec. 28, 2021, entitled PORTABLE CAMERA CONTROLLER PLATFORM FOR USE WITH PIPE INSPECTION SYSTEMS; U.S. Pat. No. 11,300,700, issued Apr. 12, 2022, entitled SYSTEM AND METHODS OF USING A SONDE DEVICE WITH A SECTIONAL FERRITE CORE STRUCTURE; U.S. patent application Ser. No. 17/868,709, filed Jul. 19, 2022, entitled INSPECTION CAMERA DEVICES AND METHODS; U.S. patent application Ser. No. 17/815,387, filed Jul. 27, 2022, entitled INWARD SLOPED DRUM FACE FOR PIPE INSPECTION CAMERA SYSTEM; U.S. Pat. No. 11,402,337, issued Aug. 2, 2022, entitled VIDEO PIPE INSPECTION SYSTEMS WITH VIDEO INTEGRATED WITH ADDITIONAL SENSOR DATA; U.S. Pat. No. 11,418,761, issued Aug. 16, 2022, entitled INSPECTION CAMERA DEVICES AND METHODS WITH SELECTIVELY ILLUMINATED MULTISENSOR IMAGING; U.S. Pat. No. 11,448,600, issued Sep. 20, 2022, entitled MULTI-CAMERA PIPE INSPECTION APPARATUS, SYSTEMS, AND METHODS; U.S. patent application Ser. No. 17/993,784, filed Nov. 23, 2022, entitled VIDEO PIPE INSPECTION SYSTEMS; U.S. Pat. No. 11,528,401, issued Dec. 13, 2022, entitled PIPE INSPECTION SYSTEMS WITH SELF-GROUNDING PORTABLE CAMERA CONTROLLERS; U.S. patent application Ser. No. 18/091,079, filed Dec. 29, 2022, entitled VIDEO INSPECTION SYSTEMS WITH WIRELESS ENABLED DRUM; U.S. patent application Ser. No. 18/148,850, filed Dec. 30, 2022, entitled SPRING ASSEMBLIES WITH VARIABLE FLEXIBILITY FOR USE WITH PUSH-CABLES AND PIPE INSPECTION SYSTEMS; U.S. Pat. No. 11,550,214, issued Jan. 10, 2023, entitled SPRING ASSEMBLIES WITH VARIABLE FLEXIBLE FOR USE WITH PUSH-CABLES AND PIPE INSPECTION SYSTEMS; U.S. Pat. No. 11,558,537, issued Jan. 17, 2023, entitled VIDEO INSPECTION SYSTEM WITH WIRELESS ENABLED CABLE STORAGE DRUM; U.S. patent application Ser. No. 18/121,547, filed Mar. 14, 2023, entitled DOCKABLE CAMERA REEL AND CAMERA CONTROL UNIT (CCU) SYSTEM; U.S. patent application Ser. No. 18/121,562, filed Mar. 14, 2023, entitled PIPE INSPECTION AND CLEANING APPARATUS AND SYSTEMS; U.S. Provisional Patent Application 63/492,473, filed Mar. 27, 2023, entitled VIDEO INSPECTION AND CAMERA HEAD TRACKING SYSTEMS AND METHODS; U.S. Pat. No. 11,614,412, issued Mar. 28, 2023, entitled PIPE INSPECTION SYSTEMS WITH JETTER PUSH-CABLE; U.S. Pat. No. 11,614,613, issued Mar. 28, 2023, entitled DOCKABLE CAMERA REEL AND CCU SYSTEM; U.S. patent application Ser. No. 18/130,341, filed Apr. 3, 2023, entitled VIDEO PUSH-CABLES FOR PIPE INSPECTION SYSTEMS; U.S. Pat. No. 11,621,099, issued Apr. 4, 2023, entitled COAXIAL VIDEO PUSH-CABLES FOR USE IN INSPECTION SYSTEMS; U.S. patent application Ser. No. 18/135,661, filed Apr. 17, 2023, entitled VIDEO PIPE INSPECTION SYSTEMS AND METHODS WITH SENSOR DATA; U.S. patent application Ser. No. 18/140,488, filed Apr. 27, 2023, entitled INTEGRATED FLEX-SHAFT CAMERA SYSTEM; U.S. Pat. No. 11,639,990, issued May 2, 2023, entitled VIDEO PIPE INSPECTION SYSTEMS WITH VIDEO INTEGRATED WITH ADDITIONAL SENSOR DATA; U.S. Pat. No. 11,649,917, issued May 16, 2023, entitled INTEGRATED FLEX-SHAFT CAMERA SYSTEM WITH HAND CONTROL; U.S. patent application Ser. No. 18/203,029, filed May 29, 2023, entitled SELF-LEVELING INSPECTION SYSTEMS AND METHODS; U.S. Pat. No. 11,665,321, issued May 30, 2023, entitled PIPE INSPECTION SYSTEM WITH REPLACEABLE CABLE STORAGE DRUM; U.S. patent application Ser. No. 18/207,898, filed Jun. 9, 2023, entitled SONDE DEVICES WITH A SECTIONAL CORE; U.S. Pat. No. 11,674,906, issued Jun. 13, 2023, entitled SELF-LEVELING INSPECTION SYSTEMS AND METHODS; U.S. Provisional Patent Application 63/510,014, filed Jun. 23, 2023, entitled INNER DRUM MODULE WITH PUSH-CABLE INTERFACE FOR PIPE INSPECTION; U.S. Pat. No. 11,709,289, issued Jul. 25, 2023, entitled SONDE DEVICES WITH A SECTIONAL FERRITE CORE; U.S. patent application Ser. No. 18/365,225, filed Aug. 3, 2023, entitled SYSTEMS AND METHODS FOR INSPECTION ANIMATION; U.S. Pat. No. 11,719,376, issued Aug. 8, 2023, entitled DOCKABLE TRIPODAL CAMERA CONTROL UNIT; U.S. patent application Ser. No. 18/490,763, filed Oct. 20, 2023, entitled LINKED CABLE-HANDLING AND CABLE-STORAGE DRUM DEVICES AND SYSTEMS FOR THE COORDINATED MOVEMENT OF A PUSH-CABLE; U.S. Provisional Patent Application 63/599,890, filed Nov. 16, 2023, entitled VIDEO INSPECTION AND CAMERA HEAD TRACKING SYSTEMS AND METHODS; U.S. patent application Ser. No. 18/528,773, filed Dec. 4, 2023, entitled PIPE INSPECTION SYSTEM CAMERA HEAD; U.S. Pat. No. 11,842,474, issued Dec. 12, 2023, entitled PIPE INSPECTION SYSTEM CAMERA HEADS; U.S. patent application Ser. No. 18/539,265, filed Dec. 14, 2023, entitled INTEGRAL DUAL CLEANER DRUM SYSTEMS AND METHODS; U.S. patent application Ser. No. 18/539,268, filed Dec. 14, 2023, entitled HIGH FREQUENCY AC-POWERED DRAIN CLEANING AND INSPECTION APPARATUS AND METHODS; U.S. Pat. No. 11,846,095, issued Dec. 19, 2023, entitled HIGH FREQUENCY AC-POWERED DRAIN CLEANING AND INSPECTION APPARATUS & METHODS; U.S. Pat. No. 11,859,755, issued Jan. 2, 2024, entitled INTEGRAL DUAL CLEANER CAMERA DRUM SYSTEMS AND METHODS; U.S. patent application Ser. No. 18/412,452, filed Jan. 12, 2024, entitled MULTI-CAMERA APPARATUS FOR WIDE ANGLE PIPE INTERNAL INSPECTION; U.S. patent application Ser. No. 18/414,785, filed Jan. 17, 2024, entitled SONDE DEVICES; U.S. Pat. No. 11,879,852, issued Jan. 23, 2024, entitled MULTI-CAMERA APPARATUS FOR WIDE ANGLE PIPE INTERNAL INSPECTION; and U.S. Pat. No. 11,880,005, issued Jan. 23, 2024, entitled SONDE DEVICES INCLUDING A SECTIONAL FERRITE CORE STRUCTURE. The content of each of these applications is incorporated by reference herein in its entirety.

In one aspect, the inner core module includes a plurality of component interfaces for electrical or mechanical components, or both. A battery module interface provides connectivity for multiple battery types and brands. The battery module interface may be replaced with other battery module interfaces to provide additional connectivity to additional battery sizes and types.

In another aspect, the interface between the cable storage drum and the outer cone is a rotation module. The rotation module may include various bearing configurations. As an example, the rotation module may include a set of front bearings, and a set of rear bearings. The rear bearings may be physically larger that the set of front bearings in order to provide removable access of the battery interface module. The set of front bearings and set of rear bearings may be partially enclosed by a clamshell assembly housing including a first half clamshell enclosure and a second half clamshell enclosure which are removably attachable to each other.

In another aspect, the inner core module may include a wireless transmit antenna positioned relatively front and center along the rotation axis of the cable storage drum all the way forward to roughly the lane of the small bearing set front side where the camera exits.

In another aspect, the cable storage drum may include various accessories. For instance, one or more cable guides, including a cable locking mechanism, may be provided. The cable guides may include wheels removed.

In another aspect, the inner core hub may be cone shaped. The inner core hub may include space, as well as interface connections for various electronics including but not limited to wireless communication electronics, cable counters, GNSS and other types of satellite positioning electronics (e.g. transmitters, receivers, transceivers, antennas, etc.), power electronics including a battery module interface, and image processing electronics including various types of processors, and memory. One skilled in the art would recognize that other electrical and mechanical systems and components related to utility camera inspection and/or communications could also be located inside the inner core hub.

In another aspect, a frame is provided for supporting a cable storage drum. The frame is configured to open and close quickly and efficiently thereby allowing the cable drum to be easily accessed for maintenance or replacement. The frame connects to the drum-reel hub, thereby, allowing the drum-reel to bidirectionally rotate around the hub.

In another aspect, the frame includes a latching system to facilitate opening and closing of the frame, and to secure (latch or lock) the cable storage drum within the frame.

In another aspect, the frame is configured to accept cable drums of various sizes and shapes. The frame may include a bearing system to facilitate rotation of the hub within the frame. The bearing system may include a removable bearing ring positioned within a bearing holder which is attached to the frame.

In another aspect, one or more cable guides may me provided. The cable guides may be attached to the frame, the drum-reel, or both. The cable guides may be stationary, or configured to be removable.

In another aspect, one or more handles may be provided. For instance, a push/pull handle may be provided, and may include a locking mechanism to allow the push/pull handle to be placed in multiple positions, and locked in place for conveniently pushing or pulling the drum-reel frame assembly via one or more wheels which may be provided, with or without a cable storage drum installed in the frame assembly.

In another aspect, a hinged or otherwise transformably coupled front frame portion may be provided to allow access to the inside of the frame for installing or removing a cable storage drum. Wheels may be provided for easily moving the frame with or without a cable storage drum installed, and may be positioned on the opposite side of a frame hinge or hinge point.

In another aspect, a latch or locking mechanism may be provided to allow the frame to be easily opened and closed. The latching or locking mechanism may be positioned on either side of the frame with respect to the hinge point.

In another aspect, a lift/carry handle may be provided for conveniently lifting and/or carrying the frame assembly, with or without a cable storage drum installed in the frame assembly. The lift/carry handle may include a handle locking mechanism which allows the lift/carry handle to be locked into a substantially upright position when in use, or folded down, and locked into place for storage when not needed.

Various additional aspects, features, and functions are described below in conjunction with the Drawings.

Details of example devices, systems, and methods that may be combined with the embodiments disclosed herein, as well as additional components, methods, and configurations that may be used in conjunction with the embodiments described herein, are disclosed in co-assigned patents and patent applications including: U.S. Pat. No. 5,939,679, issued Aug. 17, 1999, entitled VIDEO PUSH CABLE; U.S. Pat. No. 6,545,704, issued Apr. 8, 1999, entitled VIDEO PIPE INSPECTION DISTANCE MEASURING SYSTEM; U.S. Pat. No. 6,831,679, issued Dec. 14, 2004, entitled VIDEO CAMERA HEAD WITH THERMAL FEEDBACK LIGHTING CONTROL; U.S. Pat. No. 6,862,945, issued Mar. 8, 2005, entitled CAMERA GUIDE FOR VIDEO PIPE INSPECTION SYSTEM; U.S. Pat. No. 6,958,767, issued Oct. 25, 2005, entitled VIDEO PIPE INSPECTION SYSTEM EMPLOYING NON-ROTATING CABLE STORAGE DRUM; U.S. patent application Ser. No. 12/704,808, filed Feb. 13, 2009, entitled PIPE INSPECTION SYSTEM WITH REPLACEABLE CABLE STORAGE DRUM; U.S. patent application Ser. No. 13/647,310, filed Feb. 13, 2009, entitled PIPE INSPECTION SYSTEM APPARATUS AND METHOD; U.S. patent application Ser. No. 13/346,668, filed Jan. 9, 2012, entitled PORTABLE CAMERA CONTROLLER PLATFORM FOR USE WITH PIPE INSPECTION SYSTEM; U.S. patent application Ser. No. 14/749,545, filed Jan. 30, 2012, entitled ADJUSTABLE VARIABLE RESOLUTION INSPECTION SYSTEMS AND METHODS; U.S. Pat. No. 8,289,385, issued Oct. 16, 2012, entitled PUSH-CABLE FOR PIPE INSPECTION SYSTEM; U.S. Pat. No. 8,395,661, issued Mar. 12, 2013, entitled PIPE INSPECTION SYSTEM WITH SELECTIVE IMAGE CAPTURE; U.S. patent application Ser. No. 13/826,112, filed Mar. 14, 2013, entitled SYSTEMS AND METHODS INVOLVING A SMART CABLE STORAGE DRUM AND NETWORK NODE FOR TRANSMISSION OF DATA; U.S. patent application Ser. No. 14/033,349, filed Sep. 20, 2013, entitled PIPE INSPECTION SYSTEM WITH SNAP-ON PIPE GUIDES; U.S. Pat. No. 8,540,429, issued Sep. 24, 2013, entitled SNAP ON PIPE GUIDE; U.S. Pat. No. 8,587,648, issued Nov. 19, 2013, entitled SELF-LEVELING CAMERA HEAD; U.S. patent application Ser. No. 14/136,104, filed Dec. 20, 2013, entitled ROTATING CONTACT ASSEMBLIES FOR SELF-LEVELING CAMERA HEADS; U.S. patent application Ser. No. 14/203,485, filed Mar. 10, 2014, entitled PIPE INSPECTION CABLE COUNTER AND OVERLAY MANAGEMENT SYSTEM; U.S. patent application Ser. No. 14/207,527, filed Mar. 12, 2014, entitled ROTATING CONTACT ASSEMBLIES FOR SELF-LEVELING CAMERA HEADS; U.S. patent application Ser. No. 14/216,358, filed Mar. 17, 2014, entitled SMART CABLE STORAGE DRUM AND NETWORK NODE SYSTEM AND METHODS; U.S. patent application Ser. No. 14/557,163, filed Dec. 1, 2014, entitled ASYMMETRIC DRAG FORCE BEARINGS; U.S. Pat. No. 8,908,027, issued Dec. 9, 2014, entitled ASYMMETRIC DRAG FORCE BEARING FOR USE WITH PUSH-CABLE STORAGE DRUM; U.S. Pat. No. 8,970,211, issued Mar. 3, 2015, entitled PIPE INSPECTION CABLE COUNTER AND OVERLAY MANAGEMENT SYSTEM; U.S. patent application Ser. No. 14/642,596, filed Mar. 9, 2015, entitled PIPE CLEARING CABLES AND APPARATUS; U.S. Pat. No. 8,984,698, issued Mar. 24, 2015, entitled LIGHT WEIGHT SEWER CABLE; U.S. patent application Ser. No. 14/746,590, filed Jun. 22, 2015, entitled THERMAL EXTRACTION ARCHITECTURES FOR CAMERA AND LIGHTING DEVICES; U.S. Pat. No. 9,066,446, issued Jun. 23, 2015, entitled THERMAL EXTRACTION ARCHITECTURE FOR CAMERA HEADS, INSPECTION SYSTEMS, AND OTHER DEVICES AND SYSTEMS; U.S. Pat. No. 9,080,992, issued Jul. 14, 2015, entitled ADJUSTABLE VARIABLE RESOLUTION INSPECTION SYSTEMS AND METHODS; U.S. Pat. No. 9,134,255, issued Sep. 15, 2015, entitled PIPE INSPECTION SYSTEM WITH SELECTIVE CAPTURE; U.S. patent application Ser. No. 14/935,878, filed Nov. 9, 2015, entitled INSPECTION CAMERA DEVICES AND

METHODS WITH SELECTIVELY ILLUMINATED MULTISENSOR IMAGING; U.S. patent application Ser. No. 14/970,362, filed Dec. 15, 2014, entitled COAXIAL VIDEO PUSH-CABLES FOR USE IN INSPECTION SYSTEMS; U.S. Pat. No. 9,222,809, issued Dec. 29, 2015, entitled PORTABLE PIPE INSPECTION SYSTEMS AND APPARATUS; U.S. patent application Ser. No. 15/050,267, filed Feb. 22, 2016, entitled SELF-LEVELING CAMERA HEADS; U.S. Pat. No. 9,277,105, issued Mar. 1, 2016, entitled SELF-LEVELING CAMERA HEADS; U.S. patent application Ser. No. 15/264,355, filed Sep. 13, 2016, entitled HIGH BANDWIDTH VIDEO PUSH-CABLES FOR PIPE INSPECTION SYSTEMS; U.S. Pat. No. 9,448,376, issued Sep. 20, 2016, entitled HIGH BANDWIDTH PUSH-CABLES FOR VIDEO PIPE INSPECTION SYSTEMS; U.S. Pat. No. 9,468,954, issued Oct. 18, 2016, entitled PIPE INSPECTION SYSTEM WITH JETTER PUSH-CABLE; U.S. Pat. No. 9,477,147, issued Oct. 25, 2016, entitled SPRING ASSEMBLIES WITH VARIABLE FLEXIBILITY FOR USE WITH PUSH-CABLES AND PIPE INSPECTION SYSTEMS; U.S. patent application Ser. No. 15/369,693, filed Dec. 5, 2016, entitled CABLE STORAGE DRUM WITH MOVEABLE CCU DOCKING APPARATUS; U.S. Pat. No. 9,521,303, issued Dec. 13, 2016, entitled CABLE STORAGE DRUM MOVABLE CCU DOCKING APPARATUS; U.S. patent application Ser. No. 15/425,785, filed Feb. 6, 2017, entitled METHOD AND APPARATUS FOR HIGH-SPEED DATA TRANSFER EMPLOYING SELF-SYNCHRONIZING QUADRATURE AMPLITUDE MODULATION; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION; U.S. patent application Ser. No. 15/483,924, filed Apr. 10, 2017, entitled SYSTEMS AND METHODS FOR DATA TRANSFER USING SELF-SYNCHRONIZING QUADRATURE AMPLITUDE MODULATION; U.S. Pat. No. 9,625,602, issued Apr. 18, 2017, entitled SMART PERSONAL COMMUNICATION DEVICES AS USER INTERFACES; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION; U.S. patent application Ser. No. 15/590,964, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; U.S. patent application Ser. No. 15/670,845, filed Aug. 7, 2017, entitled HIGH FREQUENCY AC-POWERED DRAIN CLEANING AND INSPECTION APPARATUS AND METHODS; U.S. patent application Ser. No. 15/701,247, filed Sep. 11, 2017, entitled PIPE INSPECTION SYSTEMS WITH SELF-GROUNDING PORTABLE CAMERA CONTROLLERS; U.S. Pat. No. 9,769,366, issued Sep. 19, 2017, entitled ELF-GROUNDING TRANSMITTING PORTABLE CAMERA CONTROLLER FOR USE WITH PIPE INSPECTION SYSTEMS; U.S. Pat. No. 9,791,382, issued Oct. 17, 2017, entitled PIPE INSPECTION SYSTEM WITH JETTER PUSH-CABLE; U.S. patent application Ser. No. 15/728,410, filed Oct. 9, 2017, entitled PIPE INSPECTION SYSTEM WITH JETTER PUSH-CABLE; U.S. patent application Ser. No. 15/805,007, filed Nov. 6, 2017, entitled PIPE INSPECTION SYSTEM CAMERA HEADS; U.S. patent application Ser. No. 15/806,219, filed Nov. 7, 2017, entitled MULTI-CAMERA PIPE INSPECTION APPARATUS, SYSTEMS AND METHODS; U.S. patent application Ser. No. 15/811,264, filed Nov. 13, 2017, entitled SPRING ASSEMBLIES WITH VARIABLE FLEXIBILITY FOR USE WITH PUSH-CABLES AND PIPE INSPECTION SYSTEMS; U.S. Pat. No. 9,824,433, issued Nov. 21, 2017, entitled PIPE INSPECTION SYSTEM CAMERA HEADS; U.S. Pat. No. 9,829,783, issued Nov. 28, 2017, entitled SPRING ASSEMBLIES WITH VARIABLE FLEXIBILITY FOR USE WITH PUSH-CABLES AND PIPE INSPECTION SYSTEMS; U.S. Pat. No. 9,835,564, issued Dec. 5, 2017, entitled MULTI-CAMERA PIPE INSPECTION APPARATUS, SYSTEMS, AND METHODS; U.S. patent application Ser. No. 15/919,077, filed Mar. 27, 2018, entitled PORTABLE PIPE INSPECTION SYSTEMS AND METHODS; U.S. Pat. No. 9,914,157, issued Mar. 13, 2018, entitled METHODS AND APPARATUS FOR CLEARING OBSTRUCTIONS WITH A JETTER PUSH-CABLE APPARATUS; U.S. patent application Ser. No. 15/922,703, filed Mar. 15, 2018, entitled SELF-LEVELING INSPECTION SYSTEMS AND METHODS; U.S. Pat. No. 9,924,139, issued Mar. 20, 2018, entitled PORTABLE PIPE INSPECTION SYSTEMS AND APPARATUS; U.S. Pat. No. 9,927,368, issued Mar. 27, 2018, entitled SELF-LEVELING INSPECTION SYSTEMS AND METHODS; U.S. Provisional Patent Application 62/686,589, filed Jun. 18, 2018, entitled MULTI-DIELECTRIC COAXIAL PUSH-CABLES; U.S. Provisional Patent Application 62/726,500, filed Sep. 4, 2018, entitled VIDEO PIPE INSPECTION SYSTEMS, DEVICES, AND METHODS INTEGRATED WITH NON-VIDEO DATA RECORDING AND COMMUNICATION FUNCTIONALITY; U.S. Provisional Patent Application 62/756,538, filed Nov. 6, 2018, entitled ROBUST AND LOW COST IMPEDANCE CONTROLLED SLIP RINGS; U.S. Provisional Patent Application 62/768,760, filed Nov. 16, 2018, entitled PIPE INSPECTION AND/OR MAPPING CAMERA HEADS, SYSTEMS, AND METHODS; U.S. Provisional Patent Application 62/794,863, filed Jan. 21, 2019, entitled HEAT EXTRACTION ARCHITECTURE FOR COMPACT VIDEO HEADS; U.S. patent application Ser. No. 16/443,789, filed Jun. 17, 2019, entitled MULTI-DIELECTRIC COAXIAL PUSH-CABLES AND ASSOCIATED APPARATUS; U.S. Pat. No. 10,356,360, issued Jul. 16, 2019, entitled HIGH BANDWIDTH VIDEO PUSH-CABLE FOR PIPE INSPECTION SYSTEMS; U.S. Pat. No. 10,359,368, issued Jul. 23, 2019, entitled PIPE INSPECTION SYSTEM WITH JETTER PUSH-CABLE; U.S. Pat. No. 10,379,436, issued Aug. 13, 2019, entitled SPRING ASSEMBLIES WITH VARIABLE FLEXIBILIY FOR USE WITH PUSH-CABLES AND PIPE INSPECTION SYSTEMS; U.S. Pat. No. 10,440,332, issued Oct. 8, 2019, entitled INSPECTION CAMERA DEVICES AND METHODS WITH SELECTIVELY ILLUMINATED MULTISENSOR IMAGINING; U.S. Pat. No. 10,527,402, issued Jan. 7, 2020, entitled PIPE INSPECTION SYSTEM CABLE COUNTER AND OVERLAY MANAGEMENT SYSTEM; U.S. Pat. No. 10,585,012, issued Mar. 10, 2020, entitled PORTABLE CAMERA CONTROLLER FOR USE WITH PIPE INSPECTION SYSTEMS; U.S. Pat. No. 10,613,034, issued Apr. 7, 2020, entitled SELF-LEVELING INSPECTION SYSTEMS AND METHODS; U.S. Pat. No. 10,715,703, issued Jul. 14, 2020, entitled SELF-LEVELING CAMERA HEADS; U.S. Pat. No. 10,761,233, issued Sep. 1, 2020, entitled SONDES AND METHODS FOR USE WITH BURIED LINE LOCATOR SYSTEMS; U.S. Pat. No. 10,764,541, issued Sep. 1, 2020, entitled COAXIAL VIDEO PUSH-CABLES FOR USE IN INSPECTION SYSTEMS; U.S. patent application Ser. No. 17/087,554, filed Nov. 2, 2020, entitled PORTABLE PIPE INSPECTION SYSTEMS AND METHODS; U.S. Pat. No. 10,834,364, issued Nov. 10, 2020, entitled PORTABLE PIPE INSPECTION SYSTEMS AND METHODS; U.S. Pat. No. 10,841,144, issued Nov. 17, 2020, entitled SYSTEM AND METHODS FOR DATA TRANSFER USING SELF-SYNCHRONIZING QUADRATURE AMPLITUFE MODULATION (QAM); U.S. Pat. No. 10,855,950, issued Dec. 1, 2020, entitled HIGH BANDWIDTH VIDEO PUSH-CABLES FOR PIPE INSPECTION SYSTEMS; U.S. Pat. No. 10,863,064, issued Dec. 8, 2020, entitled CABLE STORAGE DRUM WITH MOVEABLE CCU DOCKING APPARATUS; U.S. Pat. No. 10,907,690, issued Feb. 2, 2021, entitled PIPE INSPECTION SYSTEMS WITH ASSYMETRIC DRAG FORCE BEARINGS; U.S. Pat. No. 10,921,263, issued Feb. 16, 2021, entitled PIPE INSPECTION SYSTEM WITH JETTER PUSH-CABLE; U.S. patent application Ser. No. 17/182,113, filed Feb. 22, 2021, entitled VIDEO PIPE INSPECTION SYSTEMS; U.S. patent application Ser. No. 17/202,128, filed Mar. 15, 2021, entitled BORING INSPECTION SYSTEMS AND METHODS; U.S. Pat. No. 10,955,583, issued Mar. 23, 2021, entitled BORING INSPECTION SYSTEMS AND METHODS; U.S. Pat. No. 10,976,462, issued Apr. 13, 2021, entitled VIDEO INSPECTION SYSTEMS WITH PERSONAL COMMUNICATION DEVICE USER INTERFACES; U.S. Pat. No. 10,992,849, issued Apr. 27, 2021, entitled PIPE INSPECTION SYSTEMS WITH SELF-GROUNDING PORTABLE CAMERA CONTROLLERS; U.S. Pat. No. 11,016,381, issued May 25, 2021, entitled SPRING ASSEMBLIES WITH VARIABLE FLEXIBLE FOR USE WITH PUSH-CABLES AND PIPE INSPECTION SYSTEMS; U.S. patent application Ser. No. 17/397,940, filed Aug. 9, 2021, entitled INSPECTION SYSTEM PUSH-CABLE GUIDE APPARATUS; U.S. Pat. No. 11,088,890, issued Aug. 10, 2021, entitled VIDEO INSPECTION SYSTEMS AND METHODS USING SELF-SYNCHRONIZING QAM; U.S. Pat. No. 11,132,781, issued Sep. 28, 2021, entitled PIPE INSPECTION SYSTEM CAMERA HEADS; U.S. patent application Ser. No. 17/528,155, filed Nov. 16, 2021, entitled PORTABLE CAMERA CONTROLLER PLATFORM FPR USE WITH PIPE INSPECTION SYSTEMS; U.S. Pat. No. 11,178,317, issued Nov. 16, 2021, entitled HEAT EXTRACTION APPARATUS; U.S. patent application Ser. No. 17/528,956, filed Nov. 17, 2021, entitled VIDEO INSPECTION SYSTEM APPARATUS AND METHODS WITH RELAY MODULES AND CONNECTION PORTS; U.S. patent application Ser. No. 17/531,533, filed Nov. 19, 2021, entitled INPUT MULTIPLEXED SIGNAL PROCESSING APPARATUS AND METHODS; U.S. patent application Ser. No. 17/532,938, filed Nov. 22, 2021, entitled PIPE INSPECTION AND/OR MAPPING CAMERA HEADS, SYSTEMS, AND METHODS; U.S. Pat. No. 11,187,822, issued Nov. 30, 2021, entitled SONDE DEVICES INCLUDING SECTIONAL FERRITE CORE STRUCTURE; U.S. Pat. No. 11,187,971, issued Nov. 30, 2021, entitled ROTATING CONTACT ASSEMBLIES FOR SELF-LEVELING CAMERA HEADS; U.S. Pat. No. 11,199,510, issued Dec. 14, 2021, entitled PIPE INSPECTION AND CLEANING APPARATUS AND SYSTEMS; U.S. Pat. No. 11,209,115, issued Dec. 28, 2021, entitled PIPE INSPECTION AND/OR MAPPING CAMERA HEADS, SYSTEMS, AND METHODS; U.S. Pat. No. 11,209,334, issued Dec. 28, 2021, entitled PORTABLE CAMERA CONTROLLER PLATFORM FOR USE WITH PIPE INSPECTION SYSTEMS; U.S. Pat. No. 11,300,700, issued Apr. 12, 2022, entitled SYSTEM AND METHODS OF USING A SONDE DEVICE WITH A SECTIONAL FERRITE CORE STRUCTURE; U.S. patent application Ser. No. 17/868,709, filed Jul. 19, 2022, entitled INSPECTION CAMERA DEVICES AND METHODS; U.S. patent application Ser. No. 17/815,387, filed Jul. 27, 2022, entitled INWARD SLOPED DRUM FACE FOR PIPE INSPECTION CAMERA SYSTEM; U.S. Pat. No. 11,402,337, issued Aug. 2, 2022, entitled VIDEO PIPE INSPECTION SYSTEMS WITH VIDEO INTEGRATED WITH ADDITIONAL SENSOR DATA; U.S. Pat. No. 11,418,761, issued Aug. 16, 2022, entitled INSPECTION CAMERA DEVICES AND METHODS WITH SELECTIVELY ILLUMINATED MULTISENSOR IMAGING; U.S. Pat. No. 11,448,600, issued Sep. 20, 2022, entitled MULTI-CAMERA PIPE INSPECTION APPARATUS, SYSTEMS, AND METHODS; U.S. patent application Ser. No. 17/993,784, filed Nov. 23, 2022, entitled VIDEO PIPE INSPECTION SYSTEMS; U.S. Pat. No. 11,528,401, issued Dec. 13, 2022, entitled PIPE INSPECTION SYSTEMS WITH SELF-GROUNDING PORTABLE CAMERA CONTROLLERS; U.S. patent application Ser. No. 18/091,079, filed Dec. 29, 2022, entitled VIDEO INSPECTION SYSTEMS WITH WIRELESS ENABLED DRUM; U.S. patent application Ser. No. 18/148,850, filed Dec. 30, 2022, entitled SPRING ASSEMBLIES WITH VARIABLE FLEXIBILITY FOR USE WITH PUSH-CABLES AND PIPE INSPECTION SYSTEMS; U.S. Pat. No. 11,550,214, issued Jan. 10, 2023, entitled SPRING ASSEMBLIES WITH VARIABLE FLEXIBLE FOR USE WITH PUSH-CABLES AND PIPE INSPECTION SYSTEMS; U.S. Pat. No. 11,558,537, issued Jan. 17, 2023, entitled VIDEO INSPECTION SYSTEM WITH WIRELESS ENABLED CABLE STORAGE DRUM; U.S. patent application Ser. No. 18/121,547, filed Mar. 14, 2023, entitled DOCKABLE CAMERA REEL AND CAMERA CONTROL UNIT (CCU) SYSTEM; U.S. patent application Ser. No. 18/121,562, filed Mar. 14, 2023, entitled PIPE INSPECTION AND CLEANING APPARATUS AND SYSTEMS; U.S. Provisional Patent Application 63/492,473, filed Mar. 27, 2023, entitled VIDEO INSPECTION AND CAMERA HEAD TRACKING SYSTEMS AND METHODS; U.S. Pat. No. 11,614,412, issued Mar. 28, 2023, entitled PIPE INSPECTION SYSTEMS WITH JETTER PUSH-CABLE; U.S. Pat. No. 11,614,613, issued Mar. 28, 2023, entitled DOCKABLE CAMERA REEL AND CCU SYSTEM; U.S. patent application Ser. No. 18/130,341, filed Apr. 3, 2023, entitled VIDEO PUSH-CABLES FOR PIPE INSPECTION SYSTEMS; U.S. Pat. No. 11,621,099, issued Apr. 4, 2023, entitled COAXIAL VIDEO PUSH-CABLES FOR USE IN INSPECTION SYSTEMS; U.S. patent application Ser. No. 18/135,661, filed Apr. 17, 2023, entitled VIDEO PIPE INSPECTION SYSTEMS AND METHODS WITH SENSOR DATA; U.S. patent application Ser. No. 18/140,488, filed Apr. 27, 2023, entitled INTEGRATED FLEX-SHAFT CAMERA SYSTEM; U.S. Pat. No. 11,639,990, issued May 2, 2023, entitled VIDEO PIPE INSPECTION SYSTEMS WITH VIDEO INTEGRATED WITH ADDITIONAL SENSOR DATA; U.S. Pat. No. 11,649,917, issued May 16, 2023, entitled INTEGRATED FLEX-SHAFT CAMERA SYSTEM WITH HAND CONTROL; U.S. patent application Ser. No. 18/203,029, filed May 29, 2023, entitled SELF-LEVELING INSPECTION SYSTEMS AND METHODS; U.S. Pat. No. 11,665,321, issued May 30, 2023, entitled PIPE INSPECTION SYSTEM WITH REPLACEABLE CABLE STORAGE DRUM; U.S. patent application Ser. No. 18/207,898, filed Jun. 9, 2023, entitled SONDE DEVICES WITH A SECTIONAL CORE; U.S. Pat. No. 11,674,906, issued Jun. 13, 2023, entitled SELF-LEVELING INSPECTION SYSTEMS AND METHODS; U.S. Provisional Patent Application 63/510,014, filed Jun. 23, 2023, entitled INNER DRUM MODULE WITH PUSH-CABLE INTERFACE FOR PIPE INSPECTION; U.S. Pat. No. 11,709,289, issued Jul. 25, 2023, entitled SONDE DEVICES WITH A SECTIONAL FERRITE CORE; U.S. patent application Ser. No. 18/365,225, filed Aug. 3, 2023, entitled SYSTEMS AND METHODS FOR INSPECTION ANIMATION; U.S. Pat. No. 11,719,376, issued Aug. 8, 2023, entitled DOCKABLE TRIPODAL CAMERA CONTROL UNIT; U.S. patent application Ser. No. 18/490,763, filed Oct. 20, 2023, entitled LINKED CABLE-HANDLING AND CABLE-STORAGE DRUM DEVICES AND SYSTEMS FOR THE COORDINATED MOVEMENT OF A PUSH-CABLE; U.S. Provisional Patent Application 63/599,890, filed Nov. 16, 2023, entitled VIDEO INSPECTION AND CAMERA HEAD TRACKING SYSTEMS AND METHODS; U.S. patent application Ser. No. 18/528,773, filed Dec. 4, 2023, entitled PIPE INSPECTION SYSTEM CAMERA HEAD; U.S. Pat. No. 11,842,474, issued Dec. 12, 2023, entitled PIPE INSPECTION SYSTEM CAMERA HEADS; U.S. patent application Ser. No. 18/539,265, filed Dec. 14, 2023, entitled INTEGRAL DUAL CLEANER DRUM SYSTEMS AND METHODS; U.S. patent application Ser. No. 18/539,268, filed Dec. 14, 2023, entitled HIGH FREQUENCY AC-POWERED DRAIN CLEANING AND INSPECTION APPARATUS AND METHODS; U.S. Pat. No. 11,846,095, issued Dec. 19, 2023, entitled HIGH FREQUENCY AC-POWERED DRAIN CLEANING AND INSPECTION APPARATUS & METHODS; U.S. Pat. No. 11,859,755, issued Jan. 2, 2024, entitled INTEGRAL DUAL CLEANER CAMERA DRUM SYSTEMS AND METHODS; U.S. patent application Ser. No. 18/412,452, filed Jan. 12, 2024, entitled MULTI-CAMERA APPARATUS FOR WIDE ANGLE PIPE INTERNAL INSPECTION; U.S. patent application Ser. No. 18/414,785, filed Jan. 17, 2024, entitled SONDE DEVICES; U.S. Pat. No. 11,879,852, issued Jan. 23, 2024, entitled MULTI-CAMERA APPARATUS FOR WIDE ANGLE PIPE INTERNAL INSPECTION; U.S. Pat. No. 11,880,005, issued Jan. 23, 2024, entitled SONDE DEVICES INCLUDING A SECTIONAL FERRITE CORE STRUCTURE; U.S. Provisional Patent Application 63/625,259, filed Jan. 25, 2024, entitled ACCESSIBLE DRUM-REEL FRAME FOR PIPE INSPECTION CAMERA SYSTEM; U.S. Provisional Patent Application 63/552,522, filed Feb. 12, 2024, entitled ACCESSIBLE DRUM-REEL FRAME FOR PIPE INSPECTION CAMERA SYSTEM; U.S. Pat. No. 11,909,150, issued Feb. 20, 2024, entitled ROBUST IMPEDANCE CONTROLLED SLIP RINGS; U.S. patent application Ser. No. 18/611,449, issued Mar. 20, 2024, entitled VIDEO INSPECTION AND CAMERA HEAD TRACKING SYSTEMS AND METHODS; U.S. Pat. No. 11,962,943, issued Apr. 16, 2024, entitled INSPECTION CAMERA DEVICES AND METHODS; U.S. Pat. No. 11,988,951, issued May 21, 2024, entitled MULTI-DIELECTRIC COAXIAL PUSH-CABLES AND ASSOCIATED APPARATUS; U.S. patent application Ser. No. 18/747,912, filed Jun. 19, 2024, entitled INNER DRUM MODULE WITH PUSH-CABLE INTERFACE FOR PIPE INSPECTION; U.S. Provisional Patent Application 63/719,026, filed Nov. 11, 2024, entitled PUSH-CABLE WITH OFFSET JACKET EXTRUSION; and U.S. Provisional Patent Application 63/726,858, filed Dec. 2, 2024, entitled DIGITAL SELF-LEVELING PIPE INSPECTION CAMERA SYSTEMS AND METHODS WITH AUTOMATIC MAGNIFICATION. The content of each of the above-described patents and applications is incorporated by reference herein in its entirety. The above applications may be collectively denoted herein as the “co-assigned applications” or “incorporated applications.”

### BRIEF DESCRIPTION OF THE DRAWINGS

FIG. 1A is an illustration of an embodiment of a cable storage drum for a pipe inspection system, as known in the prior art.

FIG. 1B is an illustration of an embodiment showing an inside view of a cable storage drum for a pipe inspection system, as known in the prior art.

FIG. 2A is an illustration of an embodiment of a cable storage drum with an inner drum module with a push-cable interface, in accordance with certain aspects of the present invention.

FIG. 2B is an enlarged partial view of an illustration of an embodiment of a cable storage drum with an inner drum module with a push-cable interface, in accordance with certain aspects of the present invention.

FIG. 2C is an illustration of an alternate view of an embodiment of a cable storage drum with an inner drum module with a push-cable interface, in accordance with certain aspects of the present invention.

FIG. 3 is an illustration of an embodiment of a cable storage drum 300 configured for an inner core module, in accordance with certain aspects of the present invention.

FIGS. 4A-C are illustrations of an embodiment of an inner core module, in accordance with certain aspects of the present invention.

FIG. 5 is an illustration of an an embodiment of an inner core module aligned for insertion into an outer cone of a cable storage drum, in accordance with certain aspects of the present invention.

FIG. 6 an illustration of an illustration of a cut-away view of an embodiment of a cable storage drum with an inner drum module, in accordance with certain aspects of the present invention.

FIG. 7A illustrates details of an inner core module with a battery module interface, in accordance with certain aspects of the present invention.

FIG. 7B illustrates details of an inner core module with a battery module interface populated with a battery, in accordance with certain aspects of the present invention.

FIG. 8 is an illustration of an embodiment of a front view (open) of a cable storage drum with an installed battery module, in accordance with certain aspects of the present invention.

FIG. 9 is an illustration of an embodiment of a cable storage drum with cable guides for a push-cable, in accordance with certain aspects of the present invention.

FIG. 10A is an illustration of an embodiment of a front view of an accessible drum-reel frame enclosing a cable storage drum, in accordance with certain aspects of the present invention.

FIG. 10B is an illustration of an embodiment of a side view of an accessible drum-reel frame enclosing a cable storage drum, in accordance with certain aspects of the present invention.

FIG. 10C is an illustration of an embodiment of a rear view of an accessible drum-reel frame enclosing a cable storage drum, in accordance with certain aspects of the present invention.

FIG. 10D is an illustration of an embodiment of a front view of an accessible drum-reel frame without a cable storage drum, in accordance with certain aspects of the present invention.

FIG. 10E is an illustration of an embodiment of a side view of an accessible drum-reel frame without a cable storage drum, in accordance with certain aspects of the present invention.

FIG. 10F is an illustration of an embodiment of an accessible drum-reel frame in an open position, in accordance with certain aspects of the present invention.

FIG. 11 is an illustration of an embodiment of a front interface of an accessible frame and a drum, in accordance with certain aspects of the present invention.

FIG. 12 is an illustration of an embodiment of a rear interface of an accessible frame and a drum, in accordance with certain aspects of the present invention.

FIGS. 13A-D are illustrations of embodiments of a lift/carry handle with a handle locking mechanism.

### DETAILED DESCRIPTION OF EMBODIMENTS

It is noted that as used herein, the term “exemplary” means “serving as an example, instance, or illustration.” Any aspect, detail, function, implementation, and/or embodiment described herein as “exemplary” is not necessarily to be construed as preferred or advantageous over other aspects and/or embodiments.

### Example Embodiments

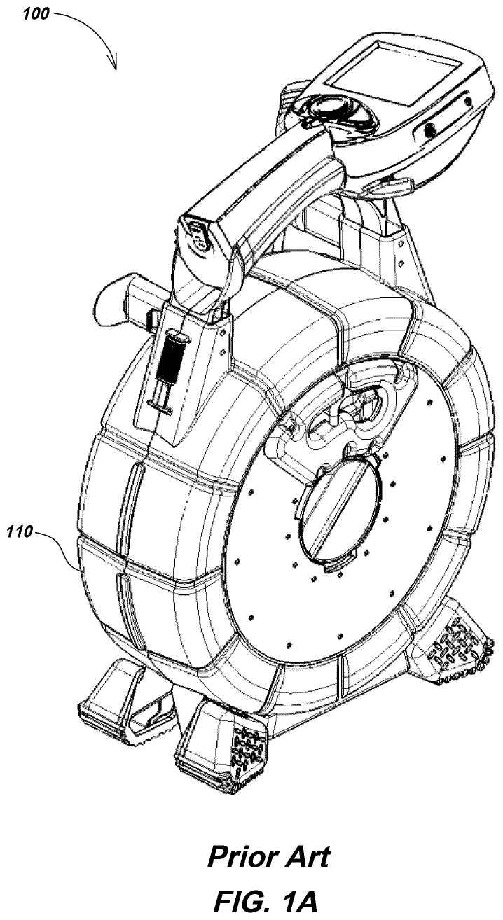

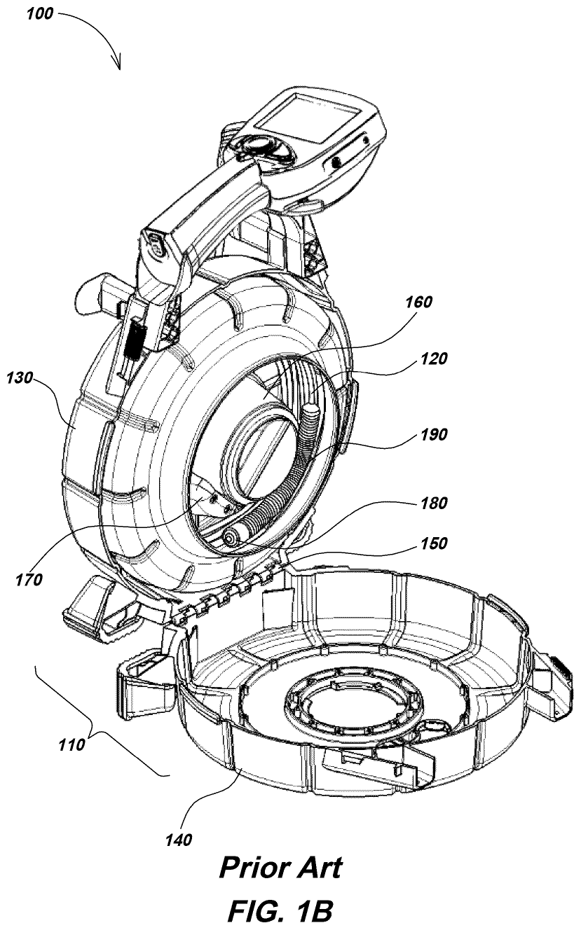

FIG. 1A illustrates details of an exemplary prior art embodiment of a cable storage drum 100 for a pipe inspection system. Cable storage drum 100 includes an outer enclosure 110 to provide a housing, as well as environmental protection for a stored push-cable (not shown).

FIG. 1B illustrates details of an exemplary prior art embodiment showing an inside view of a cable storage drum 100 for a pipe inspection system. A push-cable 120 is contained within enclosure 110. Enclosure 110 may include a first half housing 130 and a second half housing 140. The housing halves may be hinged 150 to allow access to the inside of enclosure 110. Push-cable 130 is typically attached to a rotating hub 160 via a cable attachment mechanism 170. A camera head 180 may be attached at the distal end of push-cable 130 through a flexible guiding coil 190. Hub 170 may include interfaces for one or more electrical components. Electrical connectivity is typically maintained with the rotating hub 150 through a slip-ring (not shown). One or more cable guides (not shown) may be provided to direct push-cable 120 into and out of enclosure 110.

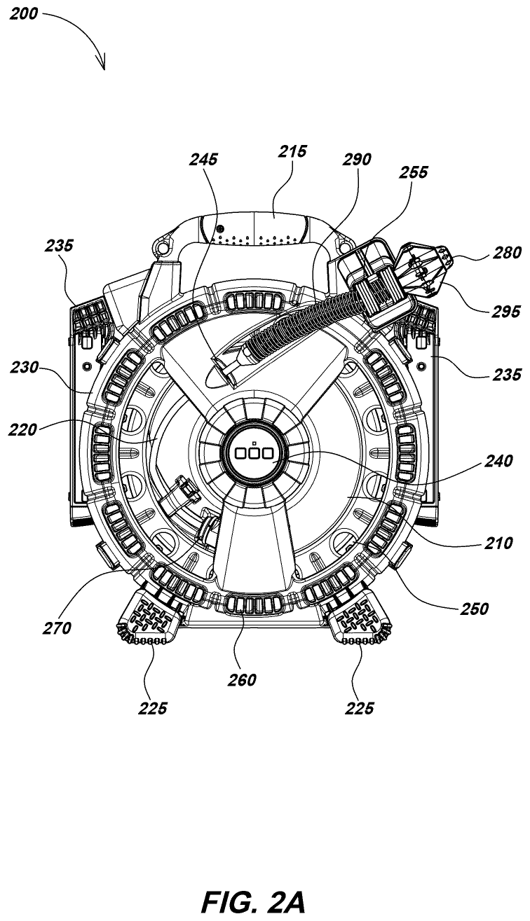

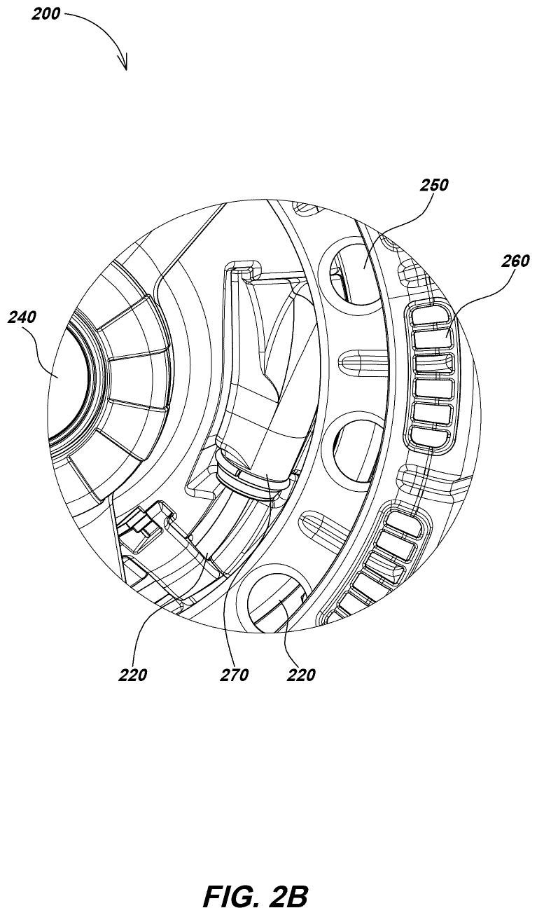

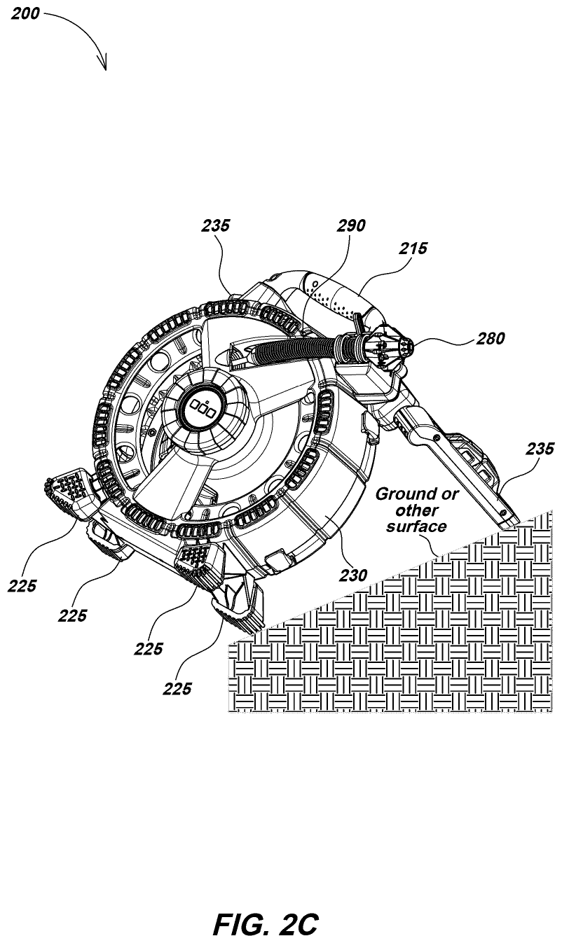

FIG. 2A illustrates details of an exemplary cable storage drum 200 with an inner drum module 210 with a push-cable 220 interface. Cable storage drum 200 includes a housing or enclosure 230 to protect inner drum module 210 and other internal components. Inner drum module 210 is capable of rotating bidirectionally around a stationary axis 240. Various sized and shaped viewing holes, slots, or windows 250 may be provided on inner drum module 210 to provide viewing of push-cable 220. Additional venting holes or slots 260 may be provided on enclosure 230 to provide venting, and to reduce the overall weight of cable storage drum 200.

Push-cable 220 may be connected to inner drum module 210 via a cable attachment mechanism 270. A camera head 280 may be attached at the distal end of push-cable 220 through a flexible guiding coil 290. One or more pipe guides 295 may be attached to camera head 280 to help guide and protect camera head 280 as it is being inserted into and out of a utility pipe or or conduit for inspection.

Cable storage drum 200 may include various accessories or components such as none or more handles 215, non-slip feet 225, and/or foldable legs 235 for allowing cable storage drum 200 to be set in multiple non-upright positions. One or more cable guides 245 and 255 may be provided to facility the movement of push-cable 220 into and out of cable storage drum 200.

FIG. 2B illustrates details of an enlarged partial view 200 of an illustration of an embodiment of a cable storage drum 200 with an inner drum module 210 with a push-cable 220 interface, in accordance with certain aspects of the present invention. Viewing holes, slots, or windows 250 allow viewing of push-cable 220 inside the cable storage drum 200. This may be useful to determine how much of the push-cable 220 is being stored in cable storage drum 200 vs how much cable is being deployed into a utility pipe or conduit, as well as providing feedback as to the general condition of the push-cable 220 (e.g. good condition vs bad condition, i.e. dirty, greasy, frayed, etc.).

FIG. 2C illustrates details of an alternate view 200 of an illustration of an embodiment of a cable storage drum 200 with an inner drum module 210 with a push-cable 220 interface, in accordance with certain aspects of the present invention. Non-slip feet 225 and foldable legs 235 allow the cable storage drum 200 to be leaned back towards the ground or other surface 265 at multiple angles which may better facilitate use of cable storage drum 200 and push-cable 220 during the inspection of a utility pipe or conduit.

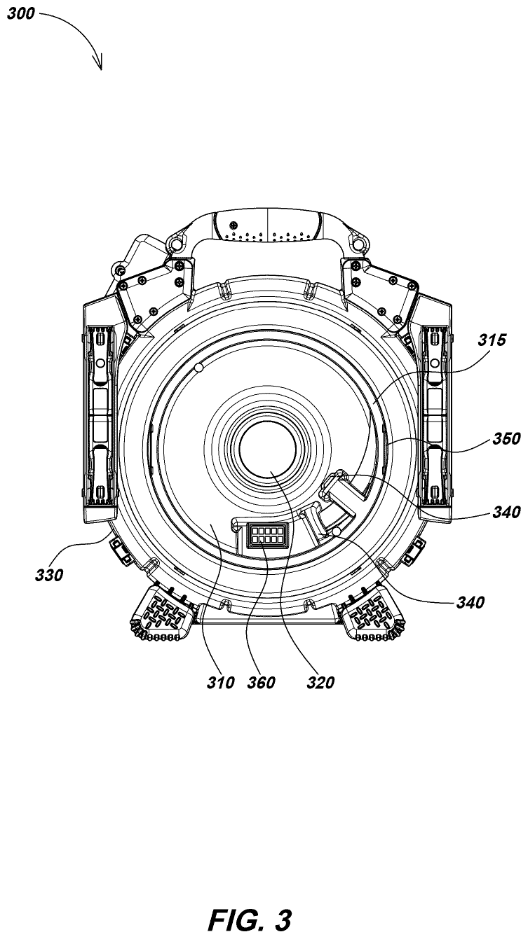

FIG. 3 illustrates details of an illustration of an embodiment of a cable storage drum 300 configured for an inner core drum module. A hollow core outer cone 310 is configured to rotate bidirectionally around a stationary axis or hub 320. An enclosure 330 provides a housing, as well as environmental protection for a stored push-cable (not shown). Enclosure 330 at least partially covers both the outer cone 310 and the stationary axis 320. Outer cone 310 is configured to rotate bidirectionally (i.e. clockwise or counter clockwise) around a stationary axis of cable storage drum 300.

Outer cone 310 is also configured to accept and mate with an inner core module (not shown) which contains various interfaces for one or more electrical and/or mechanical components, including a power source. Various shaped and sized tabs or edges 340 and grooves or indentations 350 may be provided to line up and mate with tabs and grooves on the inner core drum module (not shown). An electrical connector 360 is provided to mate with an electrical connector on inner core module 400 to provide connectivity to any electrical components connected inside inner core module 400. Once mated, outer cone 310 and the inner core module 400 are locked together relative to each other, thereby allowing both outer cone 310 and the inner core drum to move together simultaneously.

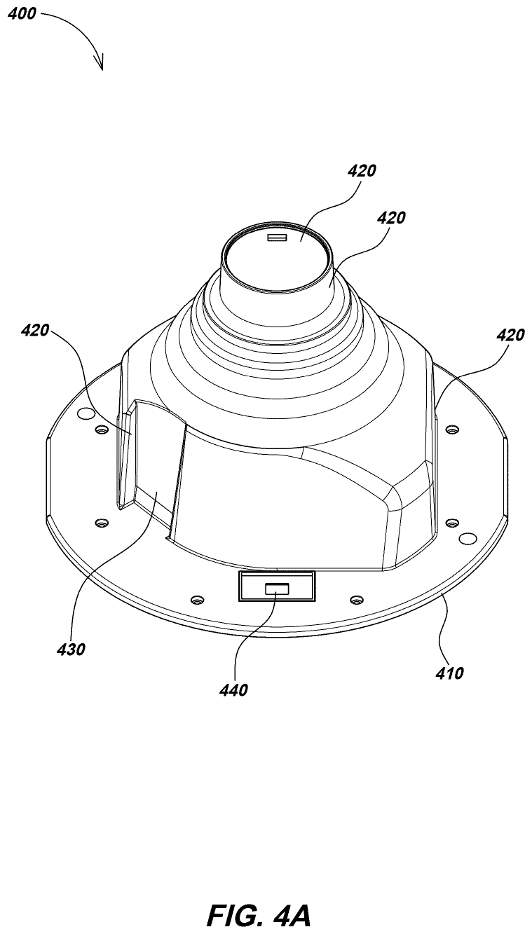

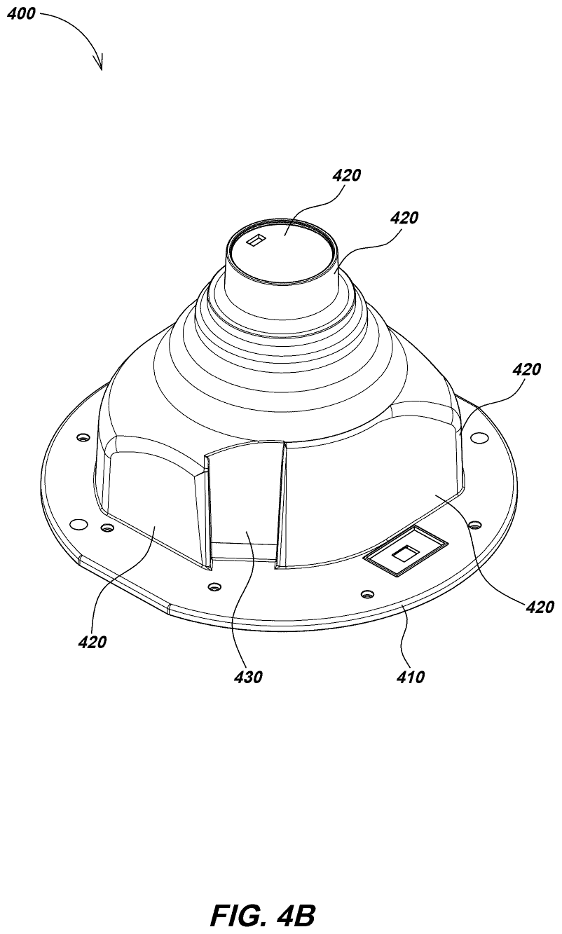

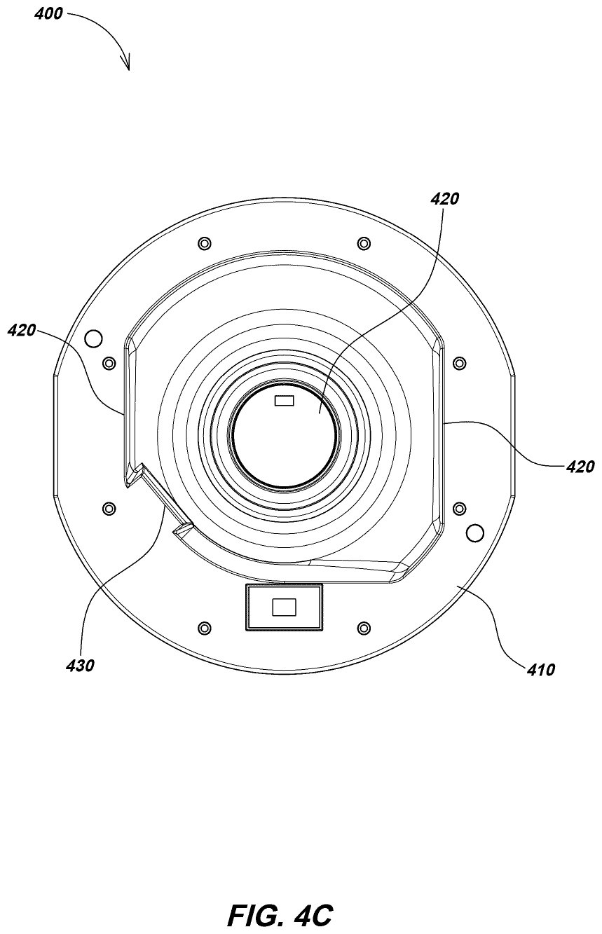

FIGS. 4A-4C illustrate details of an embodiment of an inner core module 400 for a cable storage drum. A baseplate 410 is provided to line up relatively flush with the outer cone edge 315 of outer cone 310 when the two parts are mated together. Various shaped and sized tabs or edges 420 and grooves or indentations 430 may be provided to line up and mate with tabs and grooves on the inner core drum module (not shown). An electrical connector 440 is provided to mate with an electrical connector on outer cone 310 to provide connectivity to any electrical components connected inside inner core module 400. A top down view of inner core module 400 is shown in FIG. 4C.

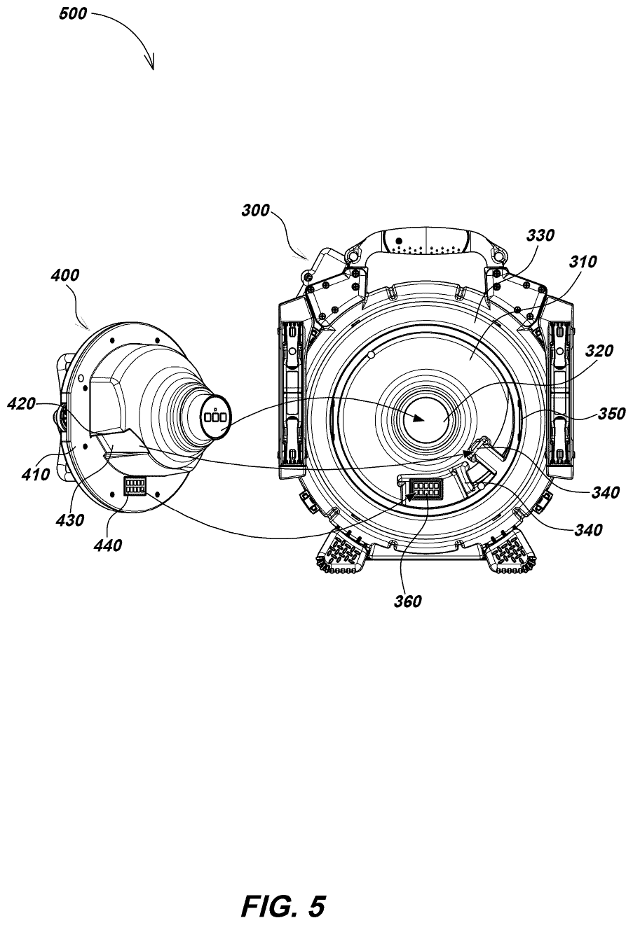

FIG. 5 illustrates details of an illustration of an embodiment 500 of an inner core module 400 aligned for insertion into an outer cone 310 of a cable storage drum. The shape of outer cone 310 is such that, when inserted, inner core module 400 will line up, and form a tight fit with outer core 310. Baseplate 410 will come in contact outer cone edge 315 of outer cone 310 when the two parts are mated together. Electrical connectors 360 and 440 will also mate when outer cone 310 and inner core module 400 are aligned and mated. Various tabs and edges 420, as well as grooves and indentations 430, of inner core module 400 may also line up with counter part tabs or edges 340 as well as grooves and indentations 350, of outer cone 310, thereby providing a more secure fit.

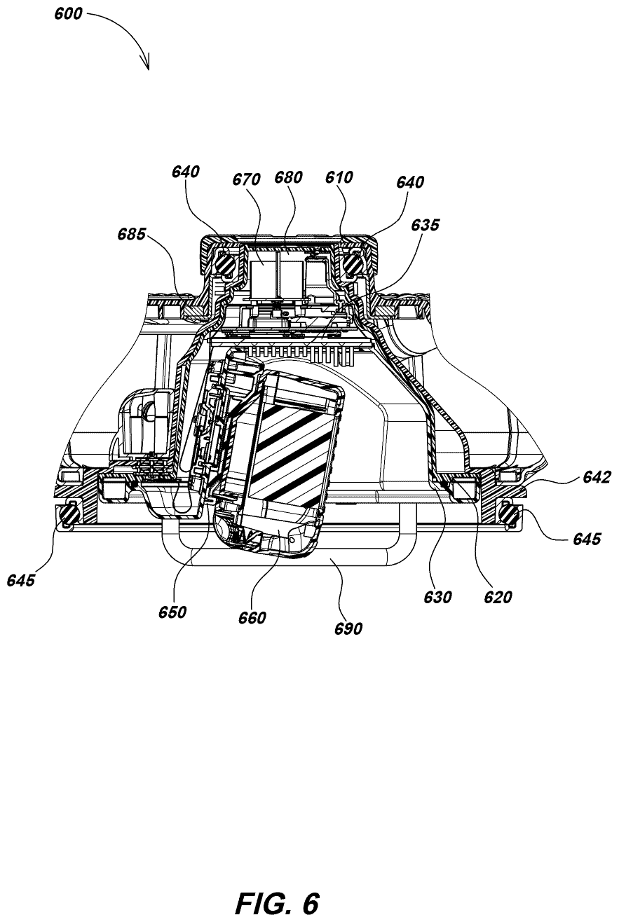

FIG. 6 is an illustration of a cut-away view of an embodiment of a cable storage drum 600 with an inner drum module, in accordance with certain aspects of the present invention. An enclosure (not shown) is provided to cover and protect all drum components. The cable storage drum 600 is attached to a ridged or semi-ridged structure or frame (not shown) via front drum hub 610. An outer cone 620 is configured to accept and mate with inner core module 630 which contains various electronic interfaces 635 (e.g. connectors, tabs, slots, and the like). When outer cone 620 and inner core module 630 are mated, they become fixed together so that when outer cone 620 rotates in one direction, inner core module 630 will rotate in the same direction.

Rear bearings 640, and front bearings 645 allow outer cone 620 and inner core module 630 to rotate bidirectionally (i.e. clockwise or counter clockwise) relative to the cable storage drum frame. Rear bearing 640 may also be referred to as small bearing because they are smaller in circumference and/or surface area to front bearings 645 which may also be referred to as large bearings. Rear bearings 640 are attached between front drum hub 610 and outer cone 620, and front bearings 645 are connected between outer cone 620 and rear drum hub 642.

A universal battery plate 650 is configured to accept, and made with various size modular battery packs 660. Various antennas 670, e.g. WiFi, GPS, GNSS, etc., as well wireless communication equipment, receivers, transmitter, transceivers, etc., may be provided. In some embodiments, interfaces may be provided to allow different types of wireless communication equipment to be added or removed. One or more magnetic sensors 680 capable of detecting one or more magnets 685 may be provided to count drum rotations relative to the frame. One or more inner core handles 690 may be provided to facility insertion and/or removal of inner core module 630 into and/or out of outer cone 620.

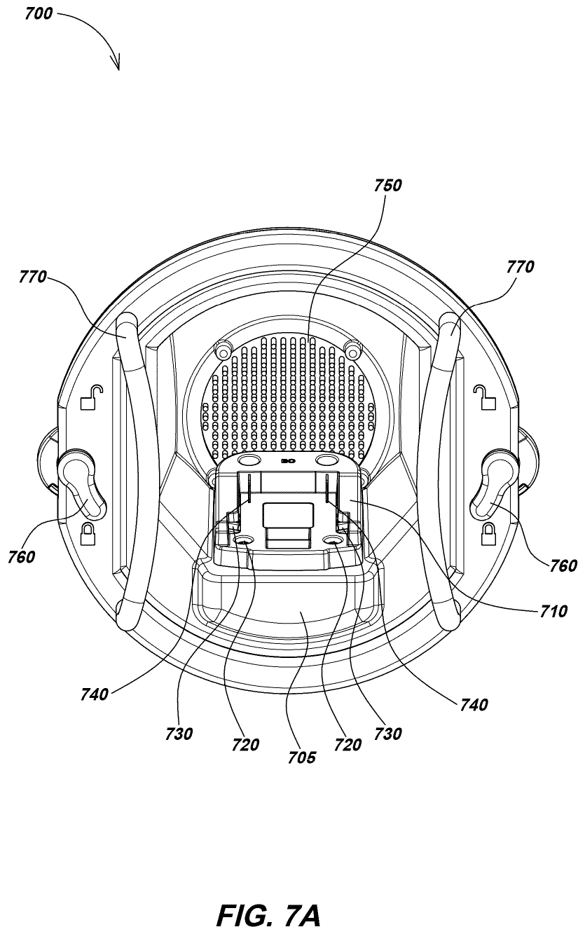

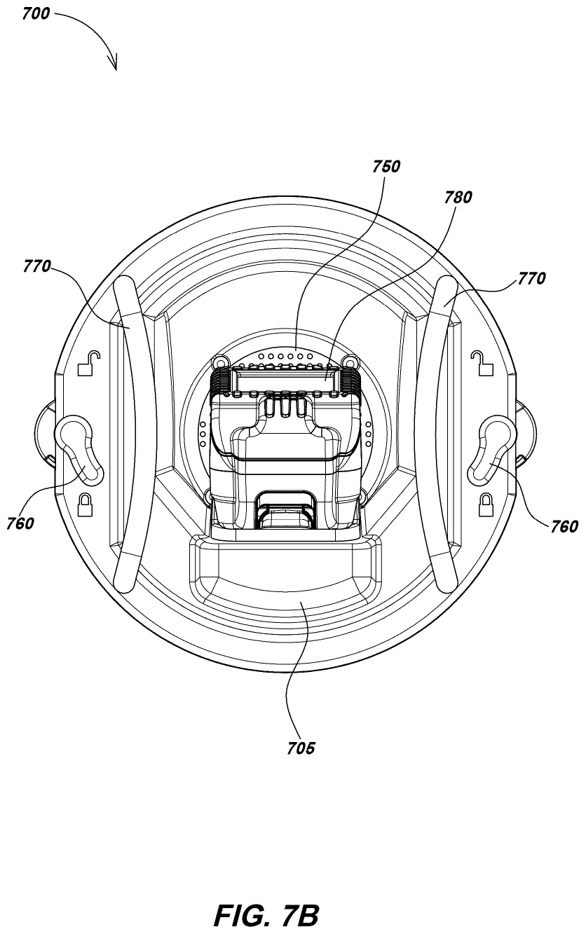

FIG. 7A illustrates details of an inner core module 700 with a battery module interface 705. The battery module interface 705 includes a replaceable battery tray 710 which is configured to accept various battery modules (not shown) of different types, electrical characteristics, and manufacturers. Battery tray 710 can be easily replaced with a different size or shape of tray to accept additional types and styles of battery modules by removing fasteners 720. Battery tray 710 includes grooves 730 for securing the battery module which may include tabs or rails which interface with the grooves 730. One or more contact tabs 740 are designed to make electrical contact with contacts provided on the battery module. A heatsink 750 is provided to help dissipate heat which may be generated by the battery module or other electrical components which may be located in the inner core module 700. Locking mechanisms 760 lock inner core module 700 into the outer cone (See FIG. 3). Handles 770 are provided to help insert and remove inner core module 700 into or out of the outer cone.

FIG. 7B illustrates details of an inner core module 700 with a battery module interface 705. Battery 780 is shown installed into battery tray 710.

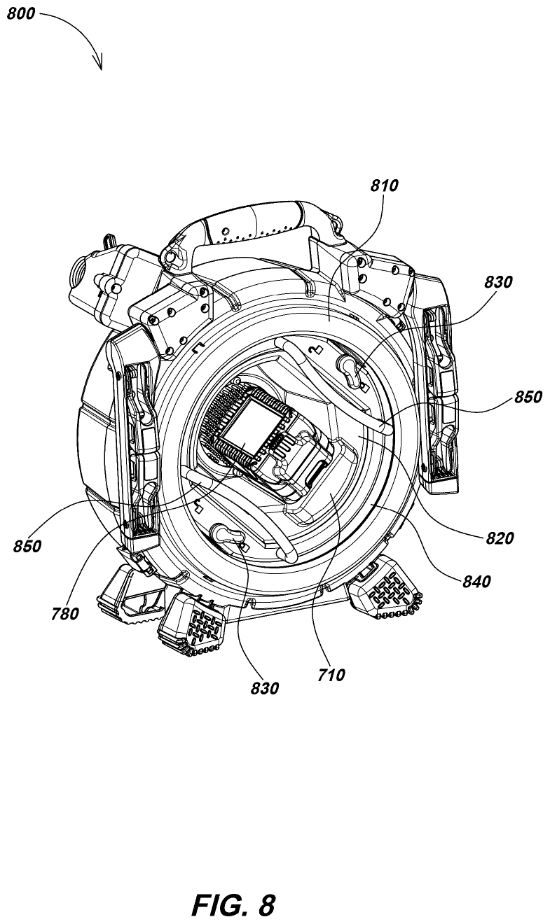

FIG. 8 illustrates details an embodiment 800 of a front view (open) of a cable storage drum 810 with an inner core module 820 installed, in accordance with certain aspects of the present invention. A battery module 780 is shown attached to inner core module 820 via battery module interface 705. One or more locking mechanisms 830 may be provided to secure the inner core module 820 to outer cone 840 which is located inside cable storage drum 810. One or more handles 850 may be provided to facilitate insertion and removal of the inner core module 820 into and out of outer cone 840. A removably attachable clamshell assembly housing including first and second half clamshell enclosures (not shown) may be provided to at least partially cover both the back and front of the cable storage drum 810, thereby providing protection to both cable storage drum components, as well as personnel.

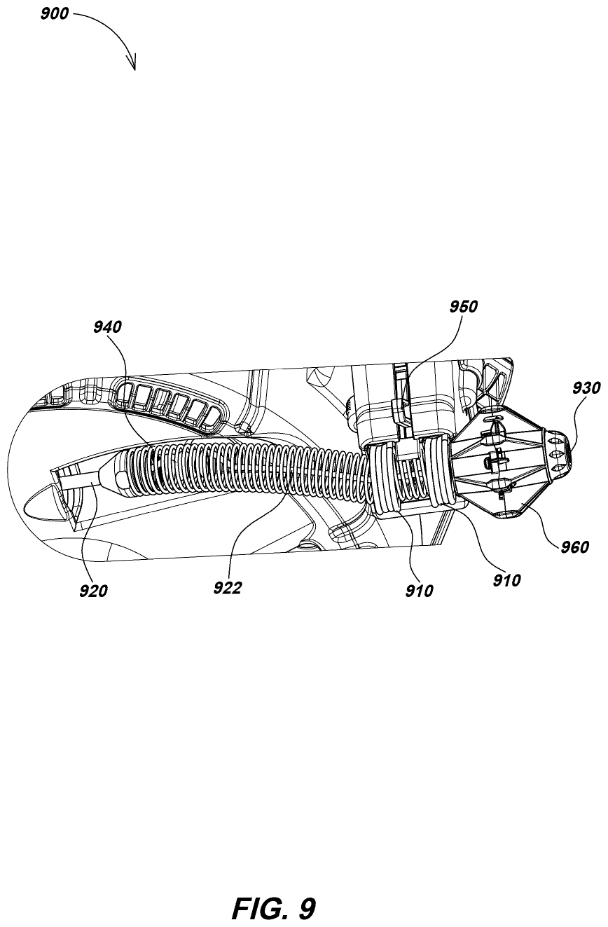

FIG. 9 illustrates details of a cable storage drum 900 with cable guides 910 for guiding a push-cable 920 into and out of cable storage drum 900. A camera head 930 may be attached to the distal end of push-cable 920. A coil 940 may be provided to help facilitate movement of push-cable 920 and a camera head 930 as it moves through a utility pipe or conduit during inspection. The push-cable 920 may be terminated at a proximal end of coil 940, and a flexmitter-flex connector (922) may then connect camera head 930 at a distal end of coil 940 to push-cable 920 through coil 940. The coil 940 will help both the push-cable 920 and camera head 930 negotiate bends and turns. A push-cable lock latch or lock 950 may be used to keep push-cable 1020 from moving during storage and transportation. A pipe guide 960 may also be attached to push-cable 920 and camera head 930 to help protect the camera head 930 as it is moving in and out of a utility or pipe during inspection.

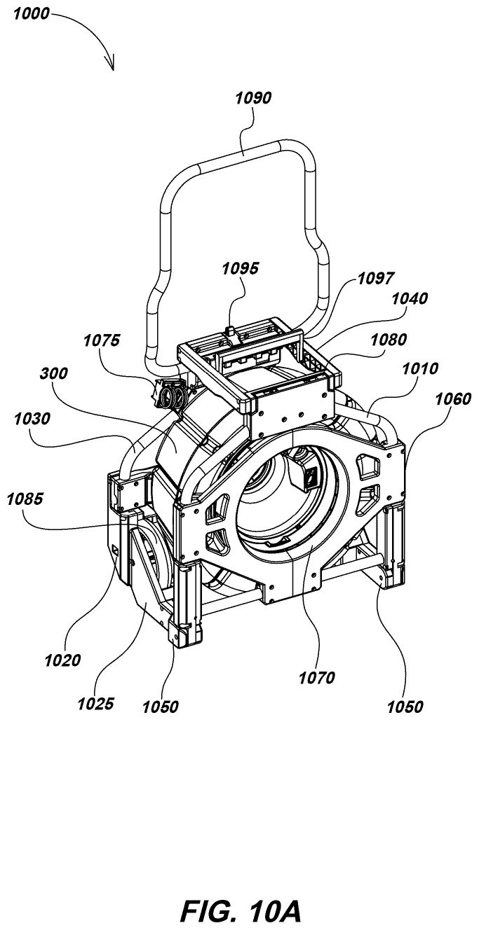

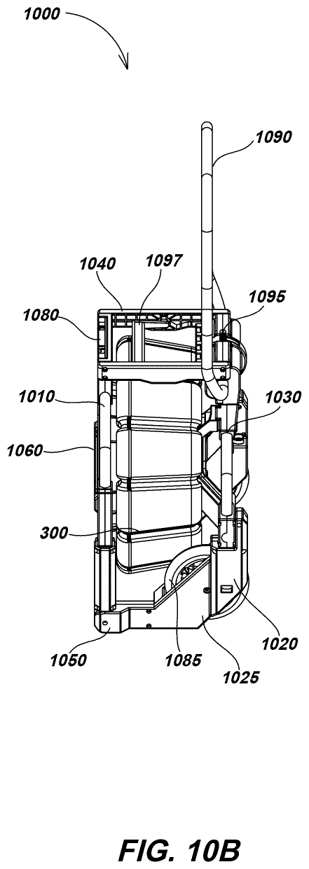

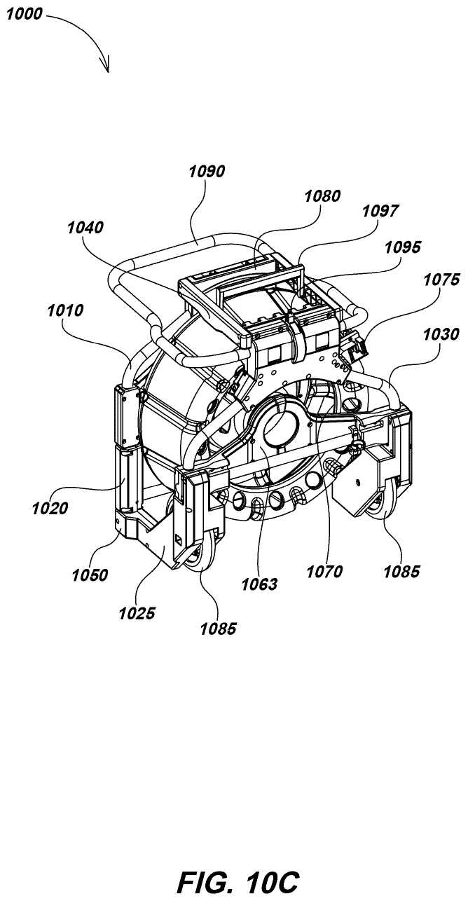

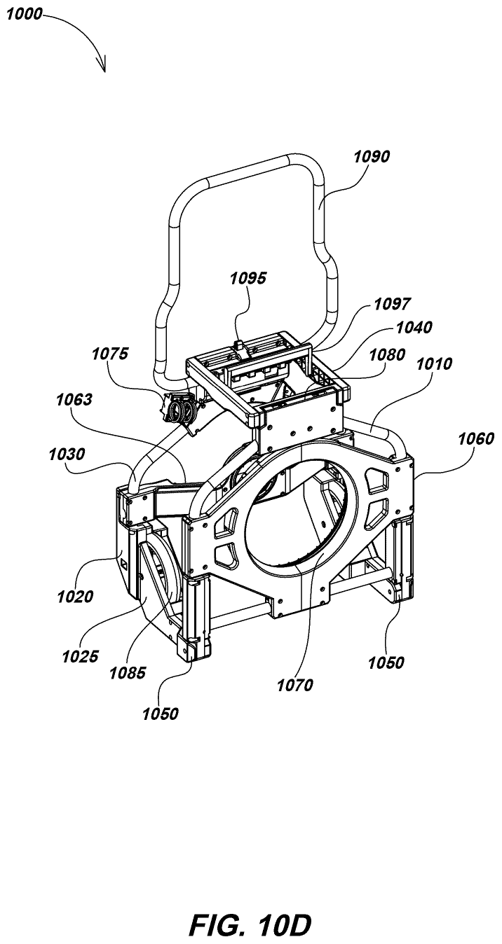

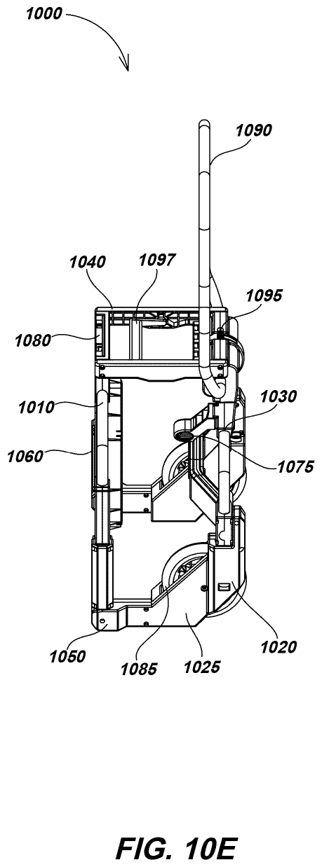

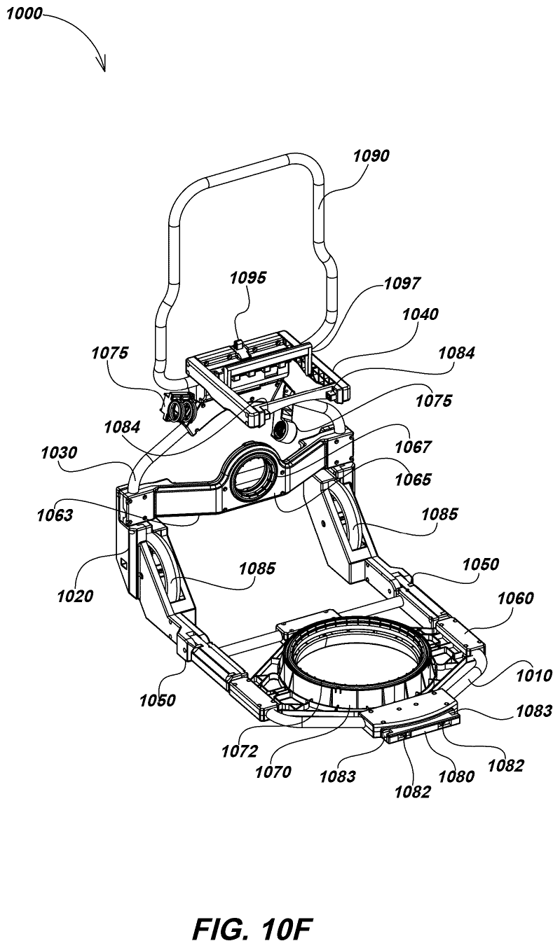

FIGS. 10A and 10B illustrate details of a drum-reel frame assembly 1000 enclosing a cable storage drum 300. The accessible drum-reel frame assembly 1000 may be a supporting frame structure with tubular elements, and may include a front frame assembly 1010, a base frame assembly 1020, a rear frame assembly 1030, and a top frame assembly 1040. All of the frame assemblies together form a substantially rigid framing system configured to secure, and partially or completely enclose a cable storage drum 300, or another size or shape storage drum (not shown). The front 1010, base 1020, rear 1030, and top frame assemblies 1040 each comprise one or more substantially rigid members. One or more hinges 1050 may be provided to allow front frame assembly 1010 to open and close allowing access to cable storage drum 300 for maintenance and/or replacement. A front frame cross member 1060 may be provided to reinforce front frame assembly 1010. Front frame cross member 1060 may include a front bearing ring holder 1070 configured to hold a front bearing ring 1072 (See FIG. 10F).

FIGS. 10A-10D show that front frame assembly 1020 rotates with respect to hinges 1050, also known as hinge points, to allow the installation or removal of a cable storage drum. It is, however, foreseeable that the hinges 1050 may be located elsewhere, thereby creating a different hinge point. For instance, the hinge point could be located closer to the wheels 1085 similar to the way existing clamshell cable storage drum enclosures are configured. In FIGS. 10A-10D a base frame cross member 1025 is provided, which separates the front frame assembly 1010 the rear frame assembly 1030. However, base frame member 1025 can be lengthened, shortened, or even removed in order to provide a different hinge point for front frame assembly 1012 via hinges 1050, or other well known assembly or method for creating a hinge point.

One or more cable guides 1075 may be provided for guiding a push-cable 120 (not shown) into or out of cable storage drum 300 as the push-cable is being wound onto or off of rotating hub 160 (not shown) which is located inside of cable storage drum 300. Cable guides 1075 are shown attached to rear frame assembly 1030, however, it would be understood by one of ordinary skill in the art that they could be provided elsewhere on the accessible drum-reel frame assembly 1000.

A frame locking mechanism 1080 may be provided for allowing front frame assembly 1010 to be closed, thereby securing it to top frame assembly 1040, or to be opened, thereby allowing front frame assembly 1010 and top frame assembly 1040 to be separated. Frame locking mechanism 1080 may interface with frame locking mechanism latches 1082 in order to facilitate quick latching and unlatching of locking mechanism 1080.

A push/pull handle 1090 which may be positioned via push/pull handle position lock 1095 may be provided. The push/pull handle may be used for carrying the accessible drum-reel frame assembly 1000 with or without drum 300, or may be used to push accessible drum-reel frame assembly 1000 with or without drum 300 via wheels 1085. A carry/lift handle 1097 may be provided as well for carrying or repositioning the accessible drum-reel frame assembly 1000. The carry/lift handle 1097 may be stationary, or may be configured to change positions by rotating around a pivot point, and may lock, latch, snap, or otherwise be secured in various positions. The carry/lift handle 1097 may be slidably positionable in a forward or backward direction to allow better balance and frame access to a user.

FIG. 10C illustrates details of an accessible drum-reel frame 1000 from a rear view. A rear frame cross member 1063 is attached to rear frame assembly 1030

FIGS. 10D (front view) and 10E (side view) illustrate details of an accessible drum-reel frame 1000 without a cable storage drum attached.

FIG. 10F illustrated details an accessible drum-reel frame 1000, shown in an open position. See FIGS. 10A and 10B above for detailed component description.

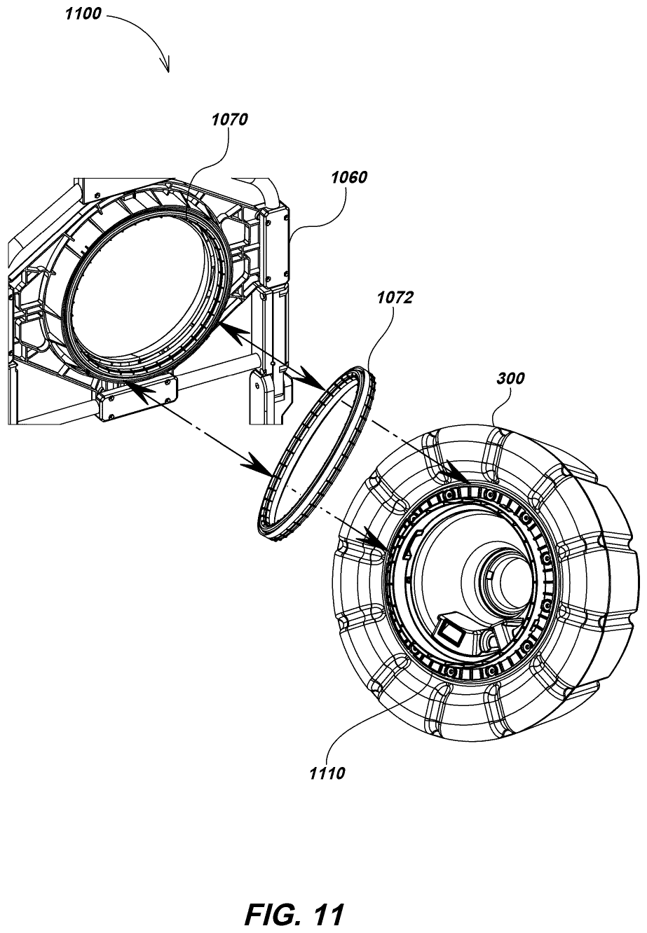

FIG. 11 illustrates details of a front interface 1100 of an accessible frame and cable storage drum 300. The front bearing ring 1072 mates on a first side with the front bearing ring holder 1070 which is attached to, or part of, the front frame cross member 1060. The front bearing ring 1072 mates on a second side with cable storage drum 300 via a drum front bearing interface 1110.

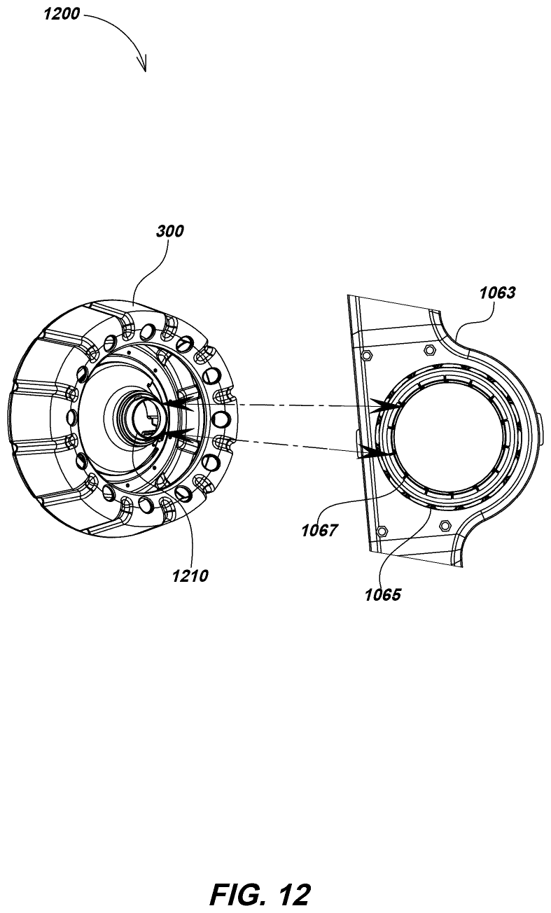

FIG. 12 illustrates details of a rear interface 1200 of an accessible frame and cable storage drum 300. The rear bearing ring 1067 mates on a first side with the rear bearing ring holder 1065 which is attached to, or part of, the rear frame cross member 1063. The rear bearing ring 1067 mates on a second side with cable storage drum 300 via a drum rear bearing interface 1210.

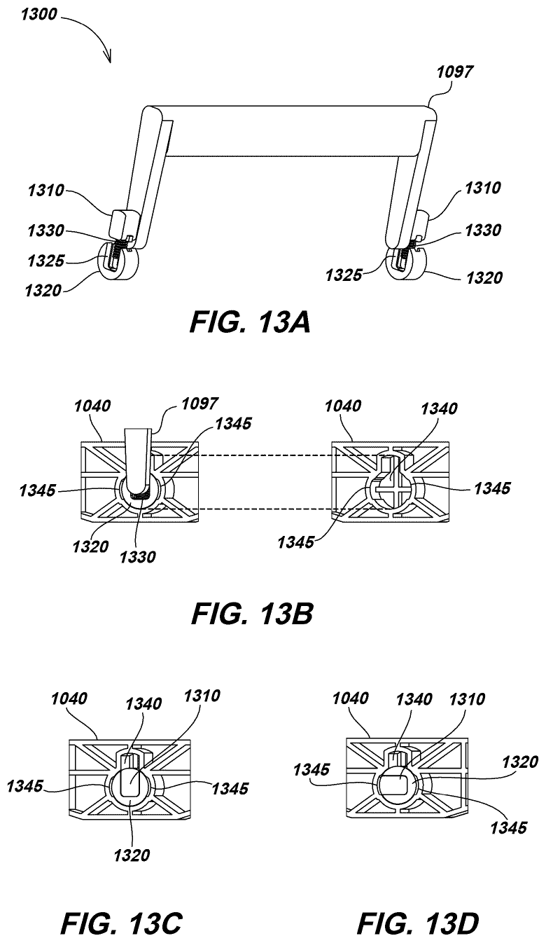

FIGS. 13A-13D illustrate details of a lift/carry handle with a handle locking mechanism 1300. As shown in FIG. 13A, lift/carry handle 1097 includes handle tabs 1310 which slide into rotating elements 1320 via rotating element slots 1325. A spring 1130 may be provided to interface between handle tabs 1310 and rotating elements 1320 inside rotating element slots 1325. In FIG. 13A springs 1130 are shown in a non-compressed position. When handle 1097 has a downward force applied to it handle tabs 1310 compress springs 1130 into rotating element slots 1325, as shown in FIG. 13B.

As shown in FIG. 13B, handle tabs 1310 and rotating elements 1320 are positioned inside a handle receiving element 1340 which may configured as part of top frame assembly 1040 as shown, or attached to top frame assembly 1040 (not shown). Rotating elements 1320 are substantially circular in shape with an opening on one end so that when handle tabs 1310, which are curved on one end, are fully inserted into rotating slots 1325, a full substantially circular shape is completed, as shown in FIG. 13C. There may be a groove, slot, or other indentation (not shown) for the spring to fit into at the bottom inside of rotating element 1320 so that when compressed, spring 1130 interfere with handle tab 1310 resting flush against the inside bottom of handle receiving element 1340.

FIG. 13C shows tab 1310 without a downward force applied to lift/carry handle 1097 (not shown) which allows spring 1330 to force tab 1310 up into the top slot of handle receiving element 1340 preventing the handle 1097 from rotating. Also, when the lift/carry handle 1097 is pulled, the weight of the accessible drum-reel frame 1000, as well as a cable storage drum 300, if installed, pulls in the opposite direction of the handle 1097 further securing the handle 1097 by preventing rotation.

FIG. 13D shows that when a downward force is applied to lift/carry handle 1097 (not shown) tab 1310 forces spring 1330 (not shown) to compress allowing tab 1310 to be inserted into rotating element slot 1325 which allows rotating element 1320 to be rotated clockwise or counter clockwise inside handle receiving element 1340. This rotation allows lift/carry handle 1097 to be stored when not needed.

Handle receiving element 1340 may include one or more divots or spaces 1345 for allowing the handle tab 1310 to be secured in place inside handle receiving element 1340 for storage. Moving lift/carry handle 1097 from a substantially upright position in either a clockwise or counter clockwise direction, forces the handle tabs 1310 to be pushed into the divots or spaces, thereby providing an audible and/or tactile “click”.

The scope of the invention is not intended to be limited to the aspects shown herein but are to be accorded the full scope consistent with the disclosures herein and their equivalents, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use embodiments of the present invention. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the disclosures herein and in the appended drawings.

We claim:

1. An accessible drum-reel frame for a pipe inspection camera system, the drum-reel frame comprising:
a frame assembly configured for attaching to, and supporting a cable storage drum, the frame assembly comprising:
a base frame portion connected with one or more frame members which form a back frame portion;
a top frame assembly connected at a first end to the back frame portion;
a hinged or otherwise transformably coupled front frame portion which attaches at a proximal end to the base frame portion, and at distal end to a second end of the top frame assembly;
at least one latching or locking mechanism for securing the distal end of the front frame portion to the second end of the top frame assembly,
a front bearing ring holder removably attachable to the front frame portion, wherein the front bearing ring holder interfaces with a front bearing ring; and
a rear bearing ring holder removably attachable to the back frame portion, wherein the rear bearing ring holder interfaces with a rear bearing ring, wherein the cable storage drum is configured to rotate bidirectionally between the front bearing ring and the rear bearing ring.

2. The drum-reel frame of claim 1, further comprising at least one handle removably attachable to the back frame portion.

3. The drum-reel frame of claim 1, further comprising a handle locking mechanism which allows at least one of the one or more handles to be placed and locked into at least two different positions.

4. The drum-reel frame of claim 1, further comprising one or more wheels attached to the base frame portion.

5. The drum-reel frame of claim 1, further comprising one or more cable guides attached to the frame assembly.

6. The drum-reel frame of claim 1, further comprising at least one handle removably attachable to the top frame assembly.

7. The drum-reel frame of claim 1, further comprising a substantially round-shaped cable storage drum.

8. The drum-reel frame of claim 7, further comprising a push-cable with a plurality of conductors, the push-cable being stored in the cable storage drum in a plurality of coils.

9. The drum-reel frame of claim 8, further comprising a drum front bearing interface for mating with the front bearing ring, and a drum rear bearing interface for mating with the rear bearing ring.

10. The drum-reel frame of claim 1, wherein the latching or locking mechanism may be opened or closed to allow the cable storage drum to be inserted or removed from the drum-reel frame.

11. The drum-reel frame of claim 9, wherein the cable storage drum further comprises:
a substantially round-shaped housing, the housing comprising:
an inner hub around which the push-cable is wound and unwound;
a substantially frame hollow core outer cone removably attachable to the cable storage drum, the hollow core outer cone including a removable inner core module, wherein the inner core module includes a plurality of component interfaces for electrical or mechanical components, or both; and
a battery module interface attached inside the inner core module, wherein the outer cone and the inner core module including the battery module interface and the plurality of component interfaces rotate simultaneously with the cable storage drum.

12. An accessible frame assembly configured for a cable storage drum in a pipe inspection camera system, the frame assembly comprising:
a base frame portion connected with one or more frame members which form a back frame portion;
a top frame assembly connected at a first end to the back frame portion;
a hinged or otherwise transformably coupled front frame portion which attaches at a proximal end to the base frame portion, and at distal end to a second end of the top frame assembly;
at least one latching or locking mechanism for securing the distal end of the front frame portion to the second end of the top frame assembly,
a front bearing ring holder removably attachable to the front frame portion, wherein the front bearing ring holder interfaces with a front bearing ring; and
a rear bearing ring holder removably attachable to the back frame portion, wherein the rear bearing ring holder interfaces with a rear bearing ring, wherein the frame assembly is configured to mate with, and secure a cable-storage drum, and wherein the frame assembly is further configured so for the cable storage drum to rotate bidirectionally between the front bearing ring and the rear bearing ring.

13. The frame assembly of claim 12, further comprising a cable storage drum.

14. The frame assembly of claim 13, wherein the cable storage drum comprises:
a substantially round-shaped housing, the housing comprising:
an inner hub around which a push-cable is wound and unwound;
a substantially frame hollow core outer cone removably attachable to the cable storage drum, the hollow core outer cone including a removable inner core module, wherein the inner core module includes a plurality of component interfaces for electrical or mechanical components, or both; and
a battery module interface attached inside the inner core module, wherein the outer cone and the inner core module including the battery module interface and the plurality of component interfaces rotate simultaneously with the cable storage drum.

15. The frame assembly of claim 14, wherein the housing includes a drum front bearing interface configured to mate with the front bearing ring of the frame assembly, and the inner hub includes a drum rear bearing interface configured to mate with the rear bearing ring of the frame assembly.

16. The frame assembly of claim 15, wherein the latching or locking mechanism may be opened or closed to allow the cable storage drum to be inserted or removed from the drum-reel frame.

17. The frame assembly of claim 12, further comprising at least one handle removably attachable to the back frame portion.

18. The frame assembly of claim 12, further comprising a handle locking mechanism which allows at least one of the one or more handles to be placed and locked into at least two different positions.

19. The frame assembly of claim 12, further comprising one or more wheels attached to the base frame portion.

20. The frame assembly of claim 12, further comprising one or more cable guides attached to the frame assembly.

21. The frame assembly of claim 12, further comprising at least one handle removably attachable to the top frame assembly.

22. The frame assembly of claim 14, wherein the plurality of component interfaces include one or more of electrical interfaces, mechanical interface, reel-counters, wireless communication equipment, and satellite positioning equipment.

23. The frame assembly of claim 22, wherein satellite positioning equipment includes GNSS equipment.

24. The frame assembly of claim 14, wherein the battery module interface provides connectivity for multiple battery types and brands.

25. The frame assembly of claim 14, wherein the battery module interface mates with a contact plate sealed inside the inner cone.

26. The frame assembly of claim 14, further comprising a camera head operatively connected to a distal end of the push-cable.

27. The frame assembly of claim 14, wherein the outer cone includes an aperture for providing front-side access to the inner cone.

28. The frame assembly of claim 14, wherein the inner cone includes a battery mounting pocket including an exposed heatsink comprising an exposed thermally conductive surface for dissipating heat away from the battery module.

29. The frame assembly of claim 22, wherein the wireless communication equipment and the satellite positioning equipment include antennas, and wherein the antennas are positioned in a front side of the inner core module near a central axis of rotation of the cable storage drum.

30. The frame assembly of claim 20, wherein the one or more cable guides comprise a split, two point cable exit guide including two feed-in/feed-out support apertures, wherein the support apertures are separated from each other by a distance of at least 4 times an inside aperture diameter.

31. The frame assembly of claim 14, the cable storage drum further comprising a plurality of electrical contacts between the inner core module and the outer cone which mate when the inner core module is installed into the outer cone, and wherein the plurality of electrical contacts provide connections for one or more of power, data, or electrical signals between the component interfaces and the camera.

32. The frame assembly of claim 14, further comprising at least one latch for securing the inner core module to the outer cone.

33. The frame assembly of claim 14, further comprising one or more operator controls exposed on an outside face of the inner core module.

34. The frame assembly of claim 14, further comprising one or more interface indicators visible on an outside face of the inner core module.

35. The frame assembly of claim 34, wherein one or more of the interface indicators is a wireless connection status LED.

36. The frame assembly of claim 34, wherein one or more of the interface indicators is a power on status LED.

37. The frame assembly of claim 20, wherein at least one of the one or more cable guides includes a camera spring locking mechanism.

38. The frame assembly of claim 14, further comprising a variable drag drum brake for slowing down or stopping rotation of the cable storage drum.

39. The frame assembly of claim 14, further comprising an internally powered drum drive module.

40. The frame assembly of claim 23, wherein the GNSS equipment includes a GNSS receiver.

41. The frame assembly of claim 22, wherein the wireless communication equipment includes a orientation sensing module.

42. The frame assembly of claim 41, wherein the orientation sensing module comprises at least one of a compass and an Inertial Navigation System (INS) sensor.

43. The frame assembly of claim 22, wherein the wireless communication equipment includes a rotation sensor for sensing rotations between the cable storage drum and the clamshell assembly.

44. The frame assembly of claim 14, further wherein the push-cable is a camera cable including a spring-loaded removable electrical interface which is mechanically secured to the cable storage drum and the outer cone assembly.

45. The frame assembly of claim 31, wherein the removable electrical interface is a three part stack assembly with a middle component connect via spring loaded contacts to an inside of the inner core module and the camera cable on an outside of the inner core module.

46. The frame assembly of claim 14, wherein the inner core module includes one or more handles.

47. The frame assembly of claim 14, wherein a NFT (Near Field Tag) is permanently or removably attached to a front exposed face of the inner core module.

48. The frame assembly of claim 14, further comprising a dry cable termination cable capture attached on an inside of the cable storage drum, and a spring contact interface attached on a reverse side of the cable storage drum that contacts at least one electronic interface inside the inner core module.

49. The drum-reel frame of claim 1, wherein the front bearing ring is removably attachable to the front bearing ring holder.

50. The drum-reel frame of claim 1, wherein the rear bearing ring is removably attachable to rear bearing ring holder.

51. The frame assembly of claim 12, wherein the front bearing ring is removably attachable to the front bearing ring holder.

52. The frame assembly of claim 12, wherein the rear bearing ring is removably attachable to rear bearing ring holder.

53. The drum-reel frame of claim 1, further comprising:
a handle with two opposing end handle tabs; and
a pair of rotating elements, wherein each rotating element includes a slot, wherein each of the two opposing handle tabs is connected to a spring, and the tabs and the springs are free to slide into and out the slots in the rotating elements, wherein when the springs are compressed between the handle tabs and the slots, the tabs and the rotating elements form a substantially circular shape thereby allowing the pair of rotating elements and the tabs to rotate freely within a pair of handle receiving elements which are configured as part of, or attached to the top frame assembly so that the handle may be placed for storage to either one of two sides, and when the springs are not compressed, the handle is locked in a substantially upright position for moving or carrying the frame.

54. The drum-reel frame of claim 53, wherein the handle receiving element includes one or more divots for locking the handle in a secured position when not in use.

55. The drum-reel frame of claim 54, wherein at least one of the one or more divots are configured to provide a tactile and audible snap when making contact with at least one of the handle tabs.
